(19) United States
(12) Patent Application Publication
(10) Pub. No.: US 2007/0106549 A1
(43) Pub. Date: May 10, 2007

(54) Turnkey aviation budget management

(76) Inventor: Christine A. Stocking, Parker, CO (US)

Correspondence Address: LEE & HAYES, PLLC, 421 W. RIVERSIDE AVE, STE 500, SPOKANE, WA, 99201, US

(21) Appl. No.: 11/267,749

(22) Filed: Nov. 4, 2005

(51) Int. Cl. G06Q 99/00; G06F 15/02; G07G 1/00; G06F 9/46; G06F 17/30

(52) U.S. Cl. 705/10; 705/1; 705/9

(57) ABSTRACT

Systems and methods for turnkey aviation budget management are described. In one aspect, a budget is determined based on a flight schedule and an operating plan for an aircraft. The operating plan is based on the flight schedule. The operating plan indicates operational flow of one or more services and equipment applicable to the aircraft between airport arrival and departure times, and corresponding fee data. Turnkey aviation budget management automatically reconciles the budget with actual fees assessed with respect to the aircraft, while the aircraft is on ground at the airport. This reconciliation process identifies any expenses not in the budget.

### BACKGROUND

Conventional techniques to manage fees charged to an aircraft on the ground at an airport (e.g., from aircraft arrival to departure) are typically ad hoc, labor-intensive, and time consuming.

### SUMMARY

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

In view of the above, turnkey aviation budget management is described. In one aspect, a budget is determined based on a flight schedule and an operating plan for an aircraft. The operating plan is based on the flight schedule. The operating plan indicates operational flow of one or more services and equipment applicable to the aircraft between airport arrival and departure times, and corresponding fee data. Turnkey aviation budget management automatically reconciles the budget with actual fees assessed with respect to the aircraft, while the aircraft is on ground at the airport. This reconciliation process identifies any expenses not in the budget

### BRIEF DESCRIPTION OF THE DRAWINGS

In the Figures, the left-most digit of a component reference number identifies the particular Figure in which the component first appears.

FIG. 1 shows an exemplary computing system for turnkey aviation budget management, according to one embodiment.

FIG. 2 shows an exemplary user interface (UI) with a main menu for turnkey aviation budget management, according to one embodiment.

FIGS. 3 through 8 show various aspects of an exemplary UI for a user to create and manage flight schedule information for an aircraft, according to respective embodiments.

FIG. 9 shows an exemplary flight schedule report menu UI, according to one embodiment. The report menu allows a user to review, print, and communicate (e.g., fax, etc.) flight schedules.

FIG. 10 shows an exemplary primary flight schedule report, according to one embodiment.

FIG. 11 shows that a user accesses forms to generate an operating plan and budget for an aircraft from the flight schedule UI, according to one embodiment.

FIG. 12 shows an exemplary operating plan flow form (UI) for a user to generate an operation plan for a select aircraft flight schedule (e.g., operating flow for crew, ground handling, fueling, catering, cleaning, customs, etc., according to one embodiment.

FIG. 13 shows an exemplary report illustrating details of operating flow based on an aircraft flight schedule, according to one embodiment.

FIGS. 14 and 15 show further aspects of the flight schedule information UI, according to one embodiment. More particularly, FIG. 14 illustrates that departure and arrival budgets for an aircraft (with a given flight schedule) is created in part by specifying contractual information (e.g., customer and/or vendor contracts).

FIGS. 16 and 17 show an exemplary UI that allows a user to specify services, equipment, and/or other products for inclusion into the aircraft operational plan and budget based on a given flight schedule, according to one embodiment.

FIG. 18 shows an exemplary contract flow details report, according to one embodiment. More particularly, FIG. 18 shows detailed specifics of services included in the aircraft operational plan and budget.

FIG. 19 shows further aspects of the flight schedule information UI for turnkey aviation budget management, according to one embodiment. More particularly, FIG. 19 illustrates that a user interfacing with the UI can access departure and arrival charge notes to specify detailed information regarding whatever happens to the aircraft, for example, at the time that an activity or event occurs.

FIGS. 20 and 21 show exemplary aspects of departure charge notes, according to one embodiment. An entity, such as a station manager, utilizes such charge notes to specify everything that happens to the aircraft while it is on the ground at an airport. As discussed below, this information is used to reconcile an aircraft budget with fees actually assessed.

FIG. 22 shows, according to one embodiment, that a user interacts with the flight schedule UI (i.e., “Reconciliations”) to reconcile an aircraft budget (based on a flight schedule, an operational plan, and expectation fees) against actually assessed fees to determine over-budget costs and related information.

FIG. 23 shows an exemplary reconciliation report generation menu UI, according to one embodiment.

FIG. 24 shows an exemplary charge note reconciliation report, according to one embodiment.

FIG. 25 shows that the predetermined contract total dollar amount shown in the exemplary contract flow details report (see also FIG. 17) does not reflect the additional fees identified by the charge note reconciliation report (i.e., FIG. 24).

FIG. 26 shows exemplary airports fees UI, according to one embodiment. The airport fees UI allows an airport to specify fees (e.g., gate fees, arrival and departure fees, security fees, immigration fees, baggage fees, etc.) that may be assessed to an aircraft on the ground at the airport responsive to certain uses and occurrences.

FIG. 27 shows exemplary aspects of an airport notes UI providing a central location for an entity to specify and/or identify detailed airport and contact information, according to one embodiment.

FIG. 28 shows an exemplary airport report menu UI to allow a user to generate various and configurable types of reports (e.g., schedule information, ground handling lists, airport fees reports, letters, etc.), according to one embodiment.

FIG. 29 shows in exemplary airport fees report, according to one embodiment

FIG. 30(a) shows an exemplary airport fees report incorporating an aircraft flight schedule and operating plan, according to one embodiment.

FIG. 30(b) shows an exemplary airport fees report that has been exported to a spreadsheet, according to one embodiment.

FIG. 31 shows an exemplary company contract information UI to specify contract specifics including contract fee information, according to one embodiment.

FIG. 32 shows further exemplary aspects of the company contract information of FIG. 31, according to one embodiment.

FIG. 33 shows an exemplary contract fee details report, according to one embodiment.

FIG. 34 shows further aspects of the exemplary contract fee details report of FIG. 33, according to one embodiment. More particularly, FIG. 35 shows that under certain conditions, an entity bound to the contract will be charged an extra fee.

FIG. 35 shows exemplary aspects of a contract fee summary report, according to one implementation.

FIG. 36 shows an exemplary entity information update form (e.g., a web page) for an entity to provide information useful to turnkey aviation budget management, according to one embodiment.

FIG. 37 shows exemplary types of information that can be updated by an entity, for example, an airport using turnkey aviation budget management, according to one embodiment.

FIG. 38 illustrates an example of a suitable computing environment in which turnkey aviation budget management may be fully or partially implemented, according to one embodiment.

FIG. 39 shows an exemplary airport gating chart generated by turnkey aviation budget management, according to one embodiment.

FIG. 40 shows an exemplary service provider report, according to one embodiment. More particularly, the illustrated report is an exemplary ground handling module report.

FIG. 41 shows an exemplary procedure for aviation budget management, according to one embodiment. More particularly, the procedure shows how an airline reconciles costs actually assessed while in aircraft is on the ground at an airport (between landing and takeoff) with a predetermined budget that takes into account airport and service/equipment provider fees.

FIG. 42 shows an exemplary procedure for turnkey aviation budget management, according to one embodiment. More particularly, the procedure shows how an airport reconciles costs actually assessed to the airport regarding in aircraft that is on the ground at the airport. The costs are reconciled in view of a previously determined set of expectation fees (a budget).

FIG. 43 shows an exemplary procedure for turnkey aviation budget management, according to one embodiment. More particularly, the procedure shows how a service/equipment provider (i.e. a provider) reconciles costs actually accrued to the provider with respect to in aircraft that is on the ground at an airport. The costs are reconciled in view of a previously determined set of expectation fees.

### DETAILED DESCRIPTION

Overview

A budget (i.e. expectation fees) for in aircraft on the ground at an airport is based on the aircraft's flight schedule and operating plan, and one or more of corresponding pre-existing fee lists and contractual obligations. Such fee lists and contractual obligations are typically related to one or more of airport fees, service and equipment provider fees, and contractual obligations (e.g., for ground handling, catering, deicing, fueling, security, customs, etc.). A budget for an airport with respect to an aircraft that is on ground at the airport, is also typically based on the aircraft's flight schedule and operating plan as well as one or more pre-existing airport fee lists and/or contractual obligations with an airline carrier (e.g., arrival and departure fees, gate fees, terminal fees, etc.). Similarly, a budget for a service/equipment provider such as a ground handler is typically based on the aircraft's flight schedule and operating plan as well as one or more pre-existing service/equipment provider fee lists and/or contractual obligations with the airline carrier (e.g., manpower, baggage handling, etc.). Thus, it is clear that various aviation industry entities rely on an aircraft's flight schedule and operating plan as well as expectation fees and contractual obligations to determine a budget for their services and/or uses.

There are no existing integrated, centrally managed, and automated systems and techniques for an aviation entity (e.g., airline carriers, service/equipment providers, charter services, etc.) to reconcile a respective budget against fees actually assessed (resulting or accrued fees) with respect to an aircraft on the ground at an airport. As a result, unexpected fee overages (i.e., fees not represented by a budget) are often assessed without any oversight and supporting basis for the extra costs. This makes identifying costs that are over-budget and determining reasons/responsibilities for the extra costs a labor-intensive and time-consuming process.

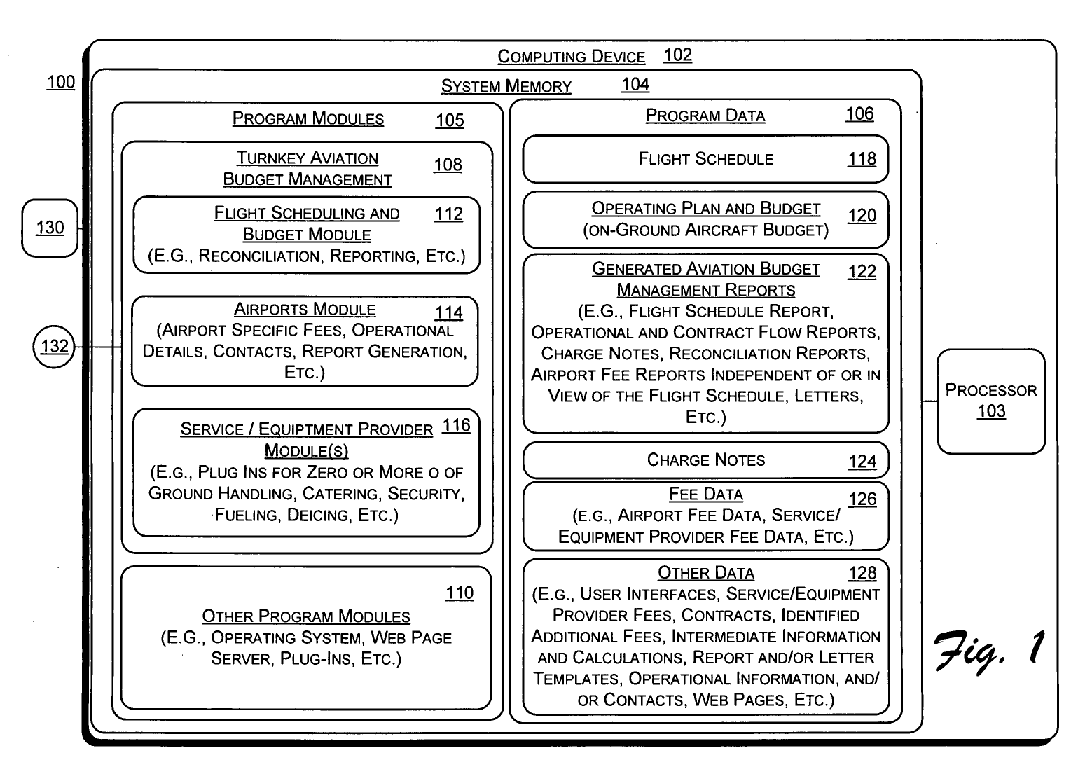

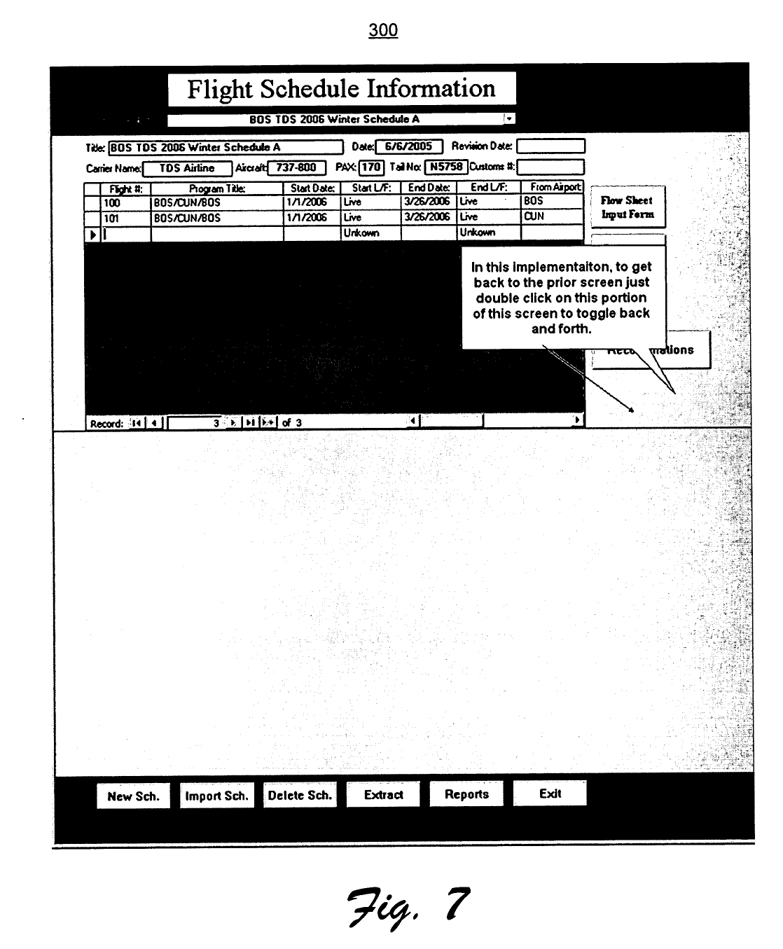

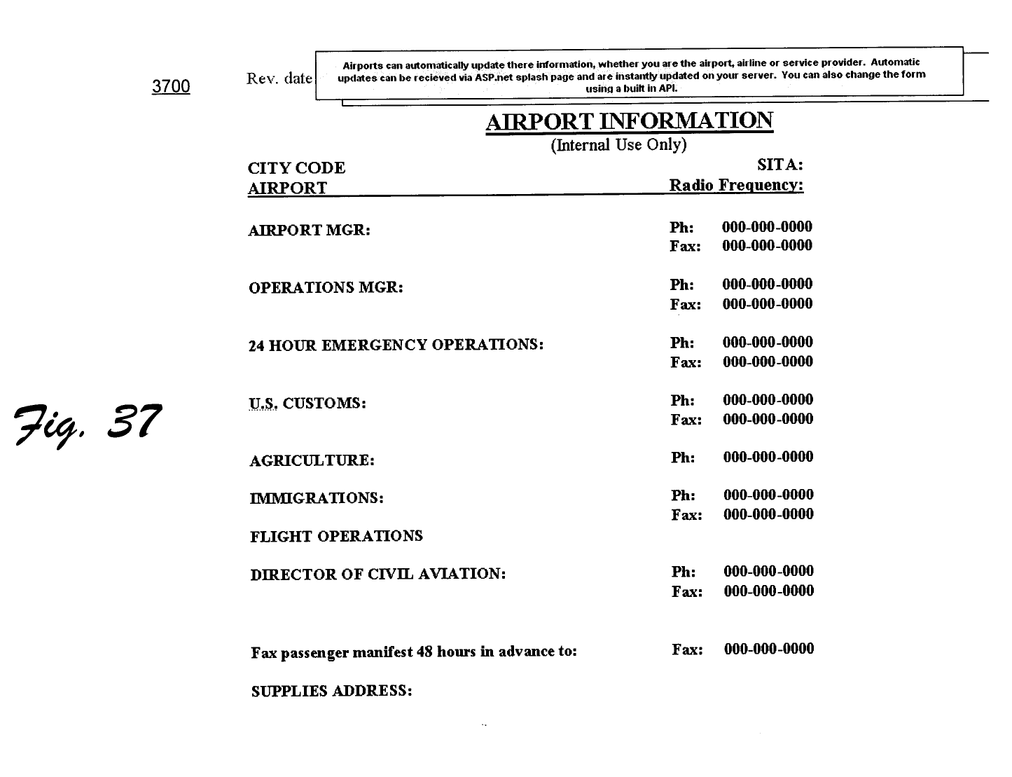

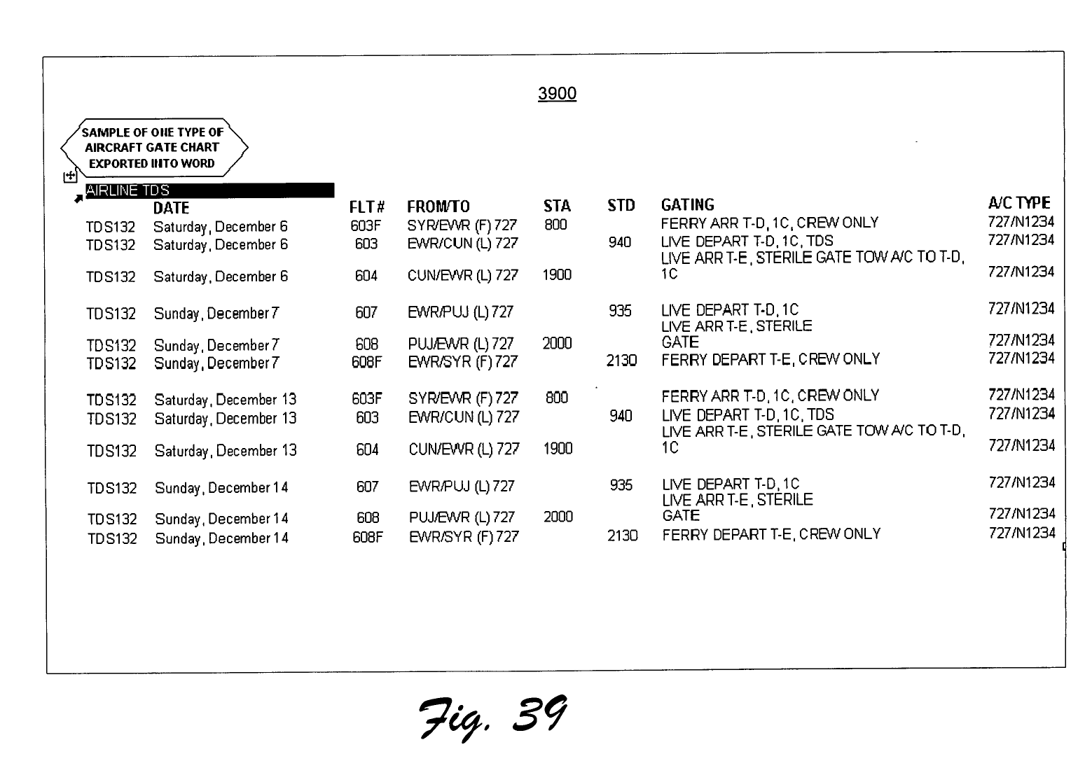

Systems and methods for turnkey aviation budget management (described below in reference to FIGS. 1 through 43) address the limitations of the above described conventional ad hoc aviation industry budget management techniques. More particularly, the systems and methods allow an aviation entity such as an airline carrier, airport, and service/equipment provider to reconcile a budget based on an aircraft flight schedule and an operating plan, against fees actually assessed while the aircraft was on the ground at the airport. More particularly, the systems and methods for turnkey aviation budget management allow a user to generate and/or import aircraft flight schedules and operating plans. (An airline carrier would typically generate an aircraft flight schedule and operating plan, whereas an airport or service/equipment provider would typically import such flights and operating plans). The systems and methods integrate the aircraft flight schedule and operating plans with one or more of pre-existing airport fees, service/equipment provider fees, contractual fee agreements, etc., to generate a corresponding budget for the aircraft from the moment the aircraft touches the ground at the airport until the aircraft takes off from the airport.

The systems and methods for turnkey aviation budget management incorporate information (charge notes) identifying substantially everything that occurs to the aircraft (while on the ground) that may have an affect on the budget. This information details anything additional that happens to the aircraft that is not in the budget (e.g., the need for an extra set of air stairs, etc.). Such information includes, for example, one or more of extra costs, responsible individuals, any additional equipment and labor (manpower) utilized, specifics of provided services, etc. The systems and methods automatically evaluate this information in view of the budget to determine and particularly point out any assessed fees that are out-of-budget, and information associated with such assessed fees. Additionally, throughout the turnkey aviation budget management operational pipeline, the systems and methods allow various entities (airlines, airports, service/equipment providers, etc.) to generate and share reports, purchase orders, affidavits, etc., to facilitate aviation budget management and reconciliation operations.

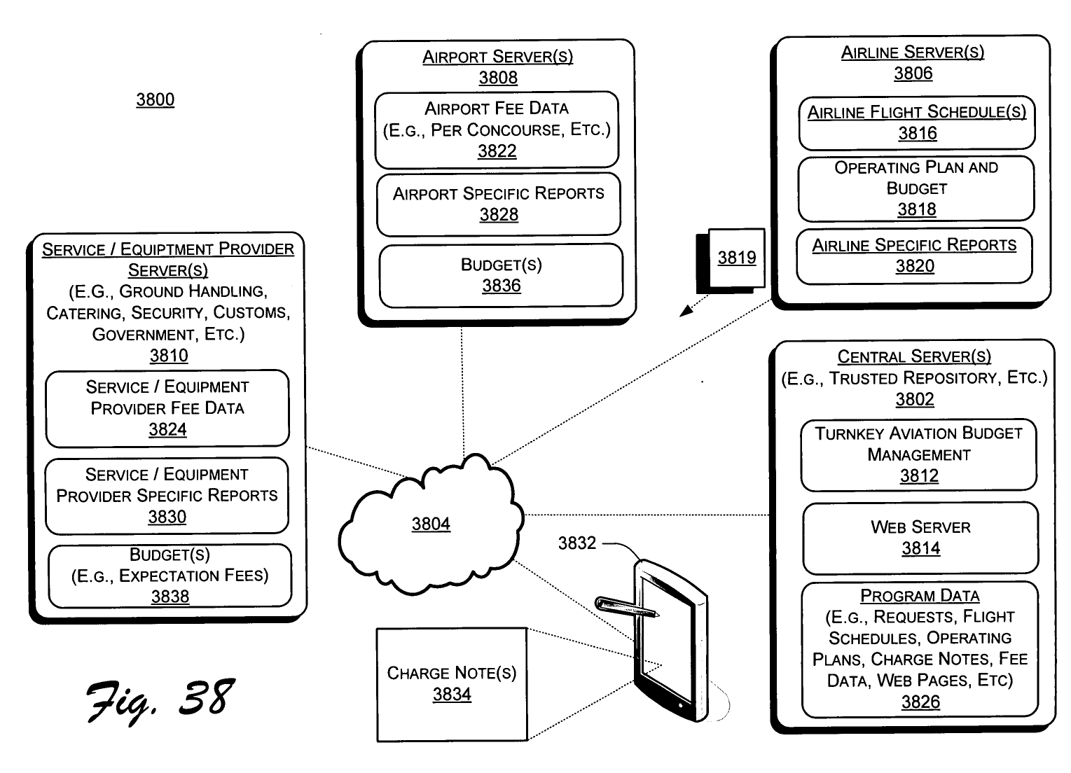

The systems and methods for turnkey aviation budget management are integrated, automated, configurable, and extensible. For example, in one implementation, the systems and methods are integrated into a single computing device for use by one or more of an airline, airport, and/or service/equipment provider(s). In another implementation, airlines, airports, and/or service/with the providers utilize the systems and methods for turnkey aviation budget management in a distributed and centrally managed computing environment (e.g., as shown in FIG. 38). Regardless of the implementation, airline flight schedules, operating plans, fee lists, etc., are shared and dynamically updated to respective systems so that airports, airlines, service/equipment providers, government agencies, etc, have current schedules, plans, and fee lists.

These and other aspects of turnkey aviation budget management are now described in greater detail.

Exemplary System

Although not required, the systems and methods for turnkey aviation budget management are described in the general context of computer-executable instructions (program modules) being executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

FIG. 1 illustrates an exemplary system 100 for turnkey aviation budget management, according to one embodiment. Examples of well-known computing systems, environments, and/or configurations that may be suitable for system 100 include, but are not limited to personal computers, server computers, multiprocessor systems, microprocessor-based systems, network PCs, minicomputers, mainframe computers, distributed computing environments that include any of the above systems or devices, and so on. Compact or subset versions of the framework may also be implemented in clients of limited resources, such as handheld computers, or other computing devices. Although system 100 is shown with a single computing device, system 100 can also be practiced in a networked computing environment where tasks are performed by remote processing devices that are linked through a communications network. An exemplary such networked computing environment is described below in reference to FIG. 38.

Referring to FIG. 1, system 100 includes computing device 102. Computing device 102 includes one or more processing units 103 coupled to system memory 104. System memory 104 includes one or more computer-readable media that can be accessed by computer 102, including both volatile and nonvolatile media, removable and non-removable media. System memory 104 includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 102.

System memory 104 includes program module(s) 105 and program data 106. Program modules include computer-program instructions executable by processor 103. In this implementation, program modules 105 include, for example, turnkey aviation budget management module 108 and other program modules 110 such as an operating system, plug-in modules, and/or so on. Turnkey aviation budget management 108 allows a user to define and manage all aspects of aircraft flight scheduling, fee determinations, and budget reconciliation for operational activities at an airport. These operational activities occur from the moment and aircraft touches the ground at the airport until the aircraft takes off from the airport. Turnkey aviation budget management 108 evaluates at least a subset of the following for budget reconciliation: operational and fee information for airports, air carrier companies, services (e.g., catering, ground handling, fueling, etc.); budgets, governing contracts, government interactions, contact information, security, manpower, etc.

Turnkey aviation budget management module 108 includes, for example, flight scheduling and budget module 112, airports module 114, and service/equipment provider specific modules 116 (e.g., plug-in modules the number and types of which are configurable; e.g., ground handling, catering, etc.). Flight scheduling and budget module 112: generates a flight schedule 118; an operating plan and budget 120; and provides for the creation of departure and arrival charge notes (respective portions of charge notes 124). For example, the flight schedule 118 describes scheduling, operational flow, contracts, services (e.g., catering, fueling, ground handling, etc.), and other information associated with an aircraft from the moment in aircraft touches the ground at an airport until the aircraft takes off from the airport. A user can directly create and edit a flight schedule 118. Alternatively, turnkey aviation budget management module 108 loads an existing flight schedule 118 from a local or a remote data source.

Airports module 114, for example, allows an airport to specify and organize substantially all fees that may be assessed to an airplane from the time that the airplane lands to the time that the airplane departs. Airport fees include, for example, fees for facilities, deplaning, enplaning, arrival and departure fees, gate use, security screening, customs, taxes, parking, terminal fees, baggage fees, aviation service provider fees, etc. Because each airport typically has a unique fee structure as compared to other airports, the airport fee module 114 allows an airport to generate a customized airport fee report (i.e., specific airport fees 126). Airport module 114 also provides for specification of airport-specific operational details and helpful contacts. Additionally, airport module 114 allows the entity to generate reports and letters based on one or more of the airport specific fees 126, the airport-specific operational details and contacts, service/equipment provider fees (shown as a respective portion of “other data” 128), and the flight schedule 118. (Service/equipment provider fees are described in greater detail below in reference to service/equipment provider module 116). Such reports and/or letters include, for example, communications directed to, or pertaining to, one or more of the following: airport service provider(s), government entities, customs, immigration, agriculture, airport authorities, airport fees, etc.).

Service/equipment provider module 116, for example, allows service and/or equipment providers to specify and organize substantially all company relevant information and fees that may be assessed to an aircraft or airport for their respective services, equipment, products, consumables, etc. For purposes of exemplary illustration, such fees are shown as a respective portion of “other data” 128. Service/equipment providers include, for example, ground handlers, deicing, fueling services, etc.

In view of the above, flight scheduling and budget module 112 allows an entity to:
generate a flight schedule 118;
create an operating plan and budget 120 in view of fee expectations (e.g., contracts and/or specific airport and service/equipment provider fee quotes) based on the flight schedule 118;
generate respective charge notes (e.g., aircraft departure and arrival charge notes, ground handling charge notes, deicing charge notes, etc.) to identify any additional assessed fees not taken into consideration by the operating plan and budget 120; and
reconcile the actual fees assessed with the budget 120.
   Reconciling the actual fees assessed with the budget 120 identifies over-budget expenses. Flight scheduling and budget module 112 allows the user to identify one or more entities responsible for the over-budget expenses, automatically generate purchase orders (reports) and other reports for services, equipment, or other subject matter associated with the over-budget expenses. In one implementation, a report showing additional expenses that are over-budget includes a signature line to allow an individual to attest to matters associated with an additional expense.

We now describe exemplary UIs, reports, etc., for a user to implement and access the above features of system 100. Turnkey aviation budget management 108 module presents these exemplary UIs, reports, etc. on a local or remote display device (e.g., display device 130).

Exemplary UIs and Reports

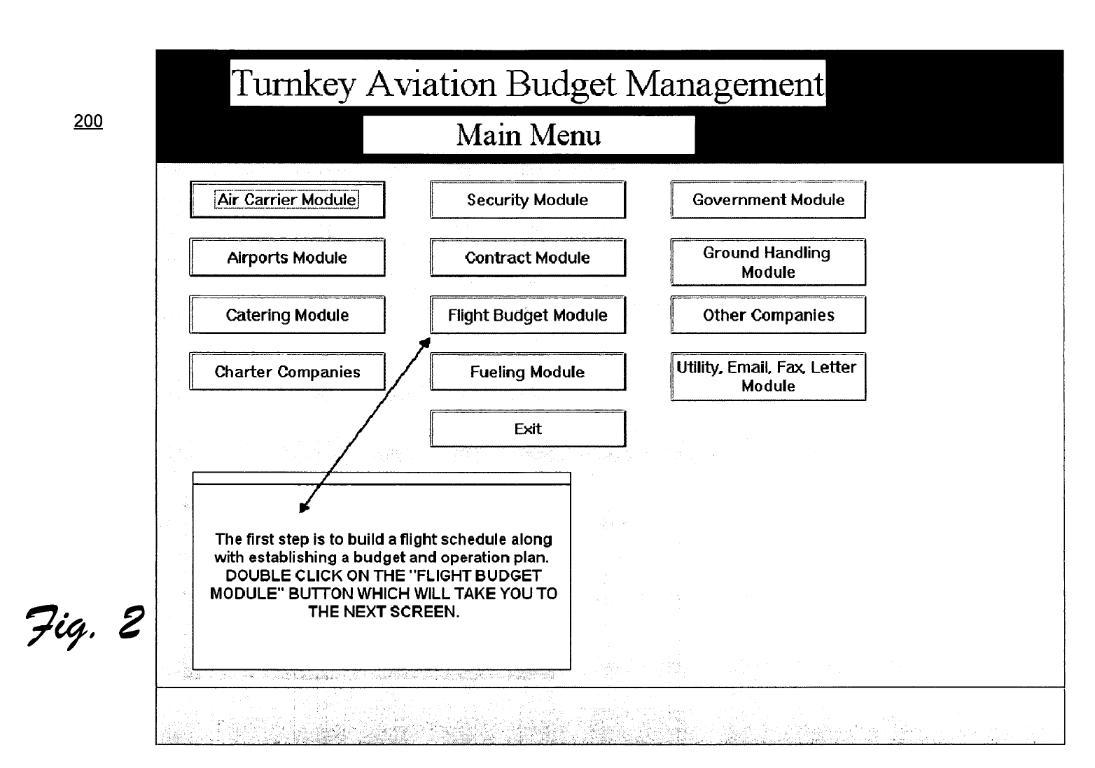

FIG. 2 shows an exemplary UI 200 with a main menu for turnkey aviation budget management, according to one embodiment. For purposes of exemplary illustration and description, the aspects of FIG. 2 are described with respect to various components of FIG. 1. The left most digit of a component reference number indicates the particular figure number where the component was/is first described.

UI 100 200 allows a user to select and interact with specific aspects of the turnkey aviation budget management. For example, user selectable UI controls on UI 200 allow a user to supply, view, interact with and distribute information related to various aspects of aviation budget management. In this example, these aspects include, for example, one or more of air carrier companies, airports, catering companies, charter companies, company contracts, contract information, budget information, fueling companies, general reports, ground handling, other companies, utility, etc. This configurable list may be expanded to include other turnkey aviation budget management features such as securities, government, manpower, and/or so on. In the example of FIG. 2 a user (associated with an airline carrier or charter service) selects the budget information category to build a flight schedule 118 (FIG. 1) and establish an operational plan and budget 120 for cost reconciliation.

### Flight Schedules, Operational Plans, and Budgets

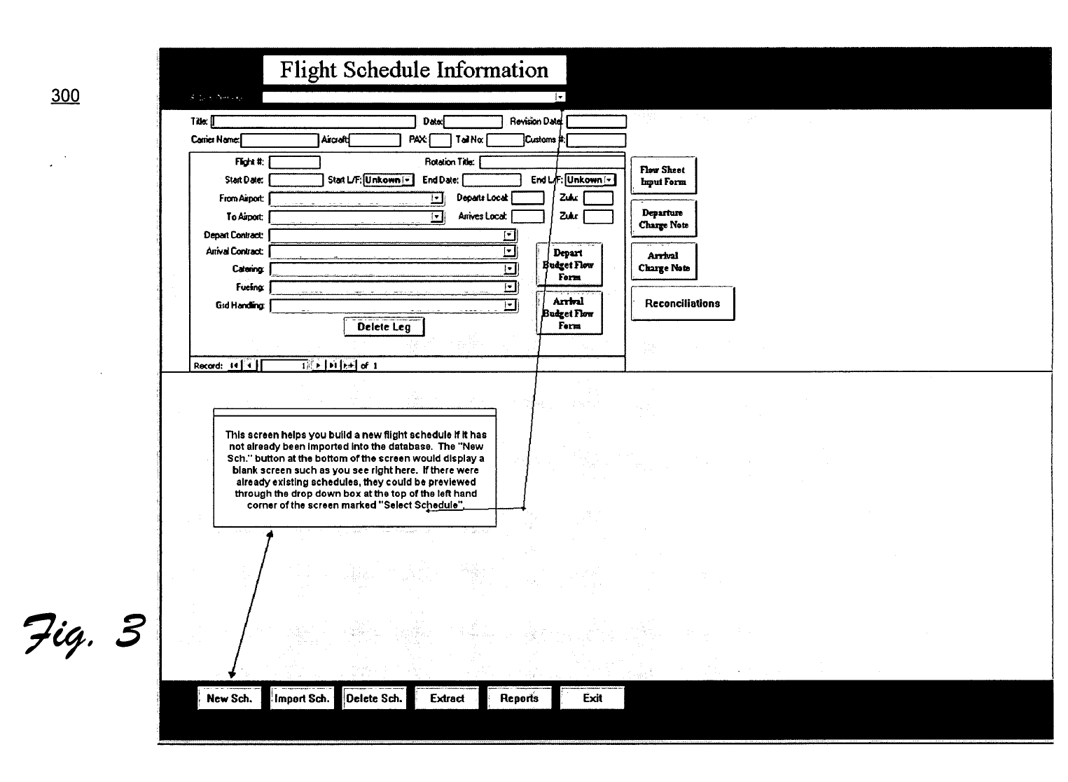

Flight scheduling and budget management module 112 of FIG. 1 displays each of the UIs of FIGS. 3 through 25 for defining, generating, and/or presenting information for flight schedules 118 and operating plan and budget 120. FIG. 3 shows an exemplary UI 300 for a user to input information to build and store a flight schedule 118, according to one embodiment. In this implementation, flight budget module 112 presents this UI 300 to the user. In one implementation, already generated flight schedules 118 are imported from one or more remote data sources/entities such as from an airline, airport, government agency, service provider, and/or so on. In this implementation, a user imports a flight schedule 118 by selecting an import schedule button on UI 300. In the example of FIG. 3, the user can designate a flight schedule 118 by carrier, aircraft, number of passengers, etc. Additional information associated with the flight schedule may include, for example, flight number, start date, and date, departure airport, arrival airport, departure contract, arrival contract, catering information, fueling, ground handling, etc.

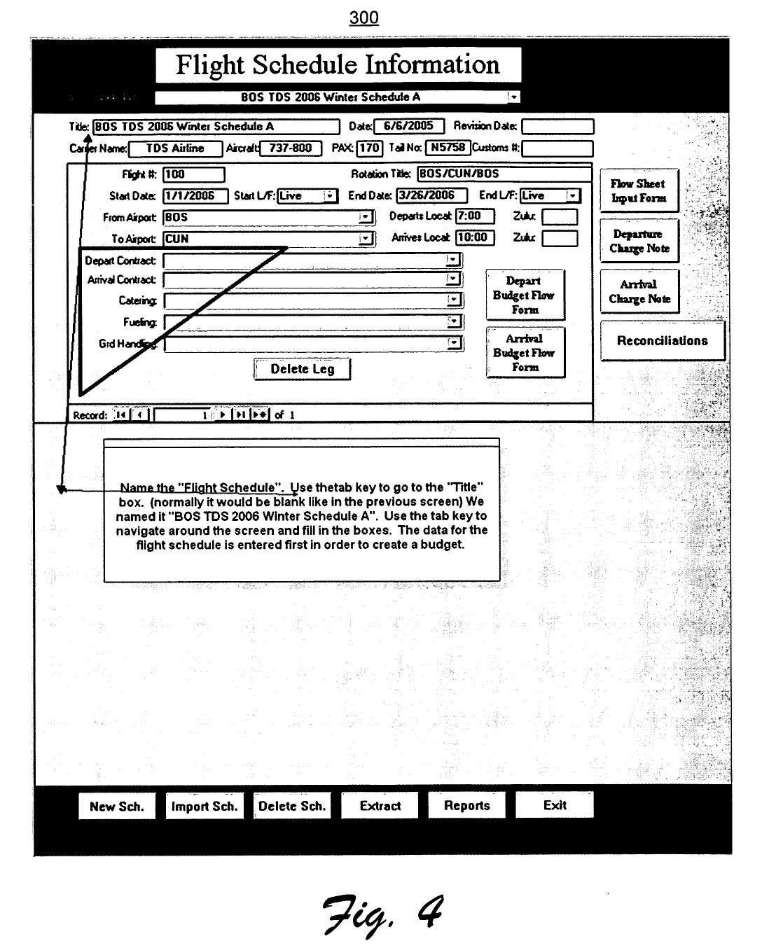

FIG. 4 shows further exemplary aspects of the flight schedule information UI 300 to designate flight schedule information, according to one embodiment. Referring to FIG. 4, a user names the flight schedule 118 and fills in at least a subset of the remaining information as appropriate. As described below, flight schedule and budget module 112 utilizes information from the flight schedule 118 in view of contracted and/or other expected fees (e.g., contracted arrival and departure fees, service provider fees, airport fees, etc.) to create an operational plan and budget 120. This operational plan and the budget 120 represents an on-ground budget. Flight scheduling and budget module 112 will reconcile fees actually accrued (e.g., from equipment providers, service providers, the airport, customs, government entities, etc.) with the operational plan and budget 120 to identify (i.e. reconcile) any additional fees that were not part of the original operating plan 120. Any such additional fees are considered out of budget.

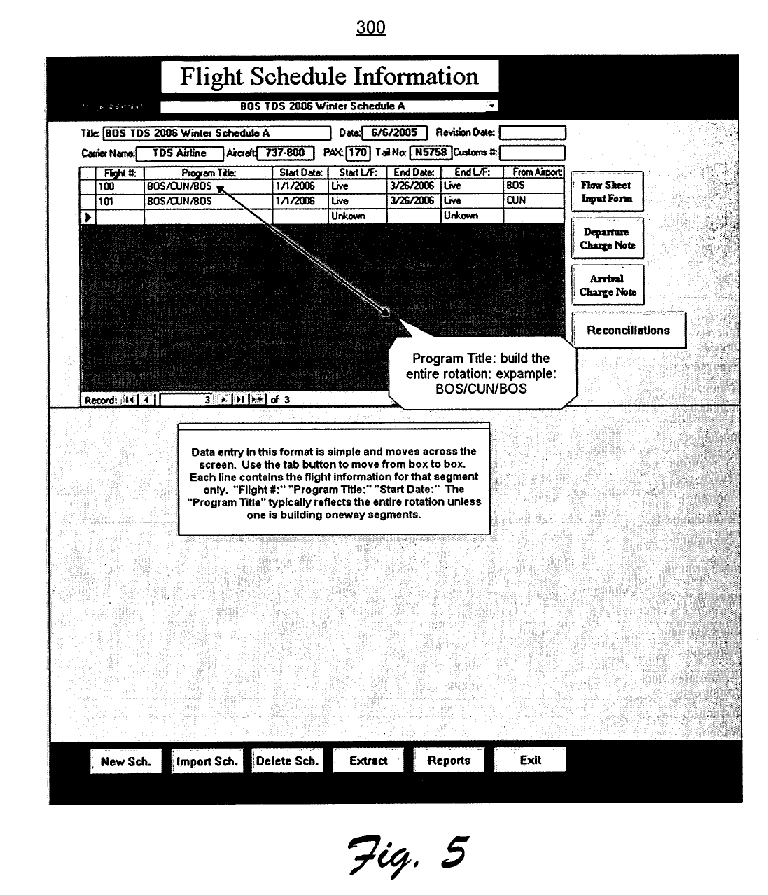

FIG. 5 shows further aspects of the exemplary flight schedule UI 300 to designate and/or review flight schedule information, according to one embodiment. The term “L/F” is known industry terminology indicating whether the flight is live (i.e., with passengers) or ferry (e.g., being placed into position for a later flight, etc.). In one embodiment, UI 300 denotes the type of flight as an unknown flight type when one is unsure whether the flight is live or ferry.

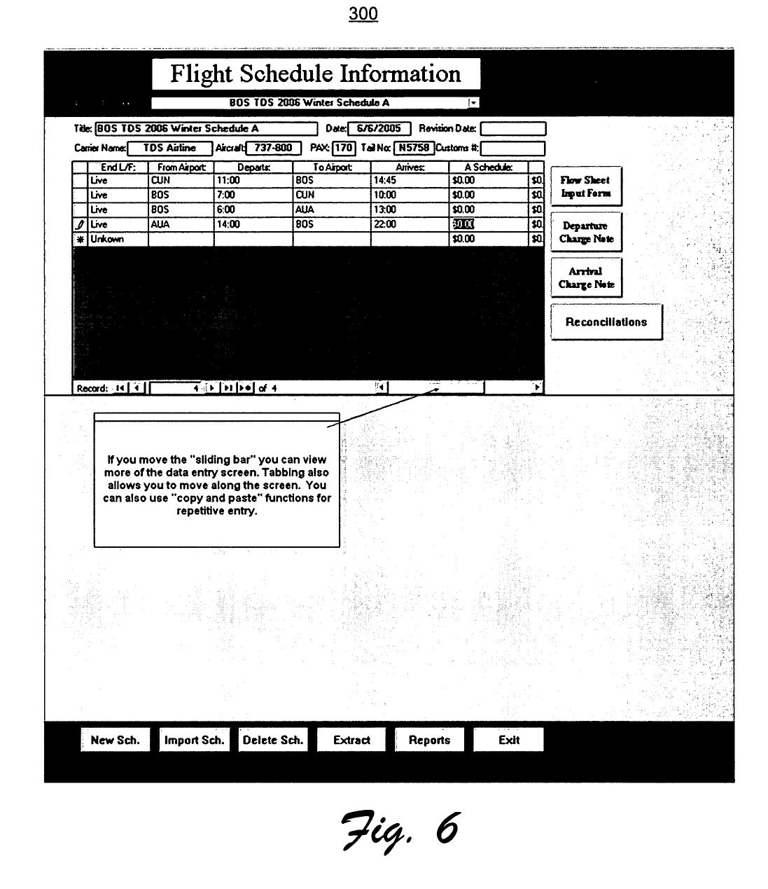

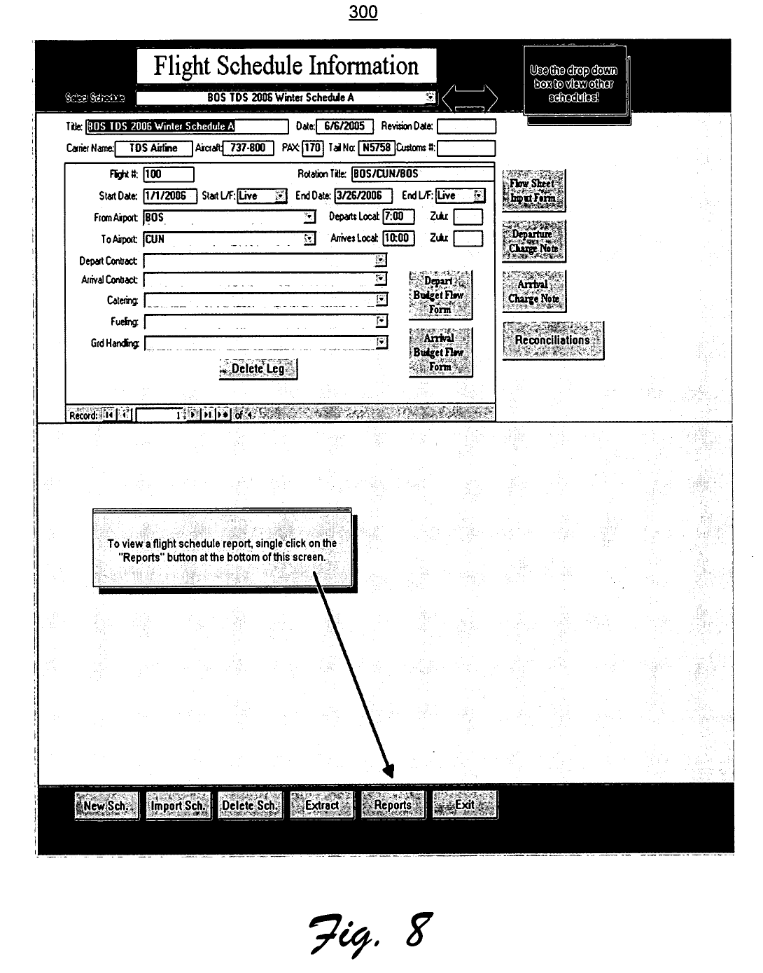

FIGS. 6 through 8 show further exemplary aspects of the flight schedule UI 300, according to one embodiment. In the example of FIG. 6, the column titled “A Schedule” allows a user to specify revenue streams/costs (e.g., gross revenue, net revenue, etc.) of the particular segment. FIG. 8 shows that to review a flight schedule report (i.e., a respective “generated aviation budget management report” 122), a user can select a particular UI button control.

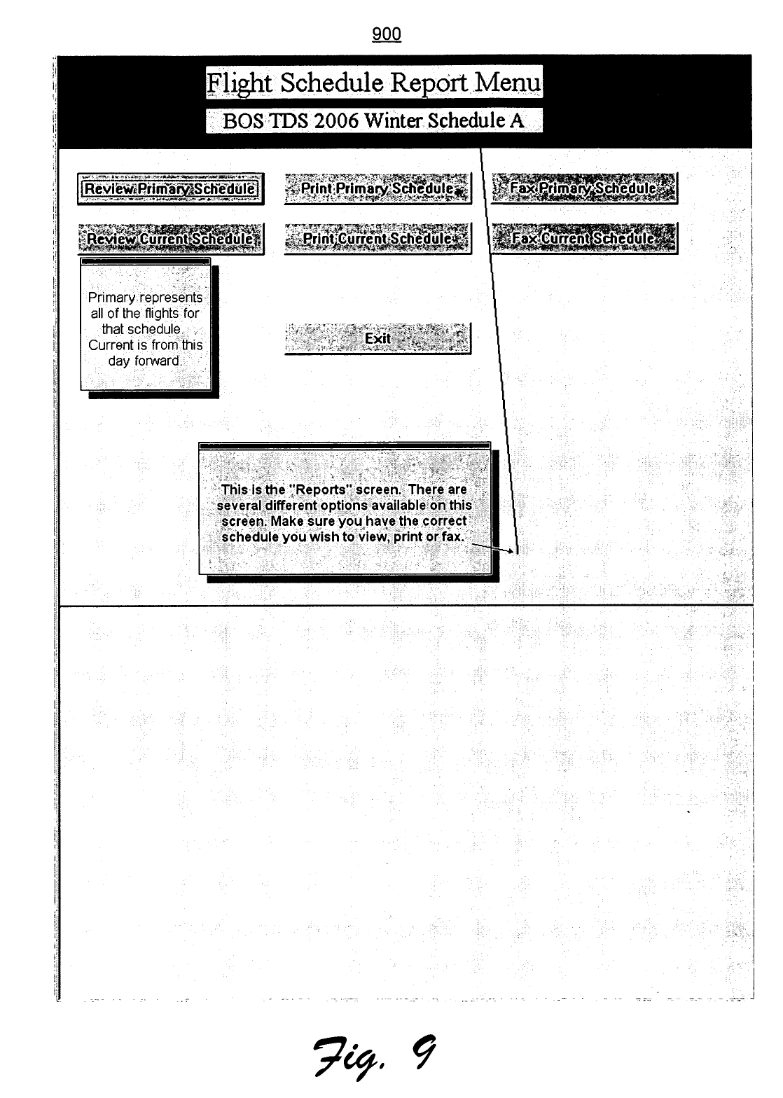

FIG. 9 shows an exemplary flight schedule report menu UI 900, according to one embodiment. Flight budget module 112 presents this UI 900 to allow a user to review information associated with flight schedule 118. In this example, a user can review a primary schedule, review a current schedule, print a primary schedule, print a current schedule, or communicate (e.g., fax etc.) the primary and/or current schedule to another entity.

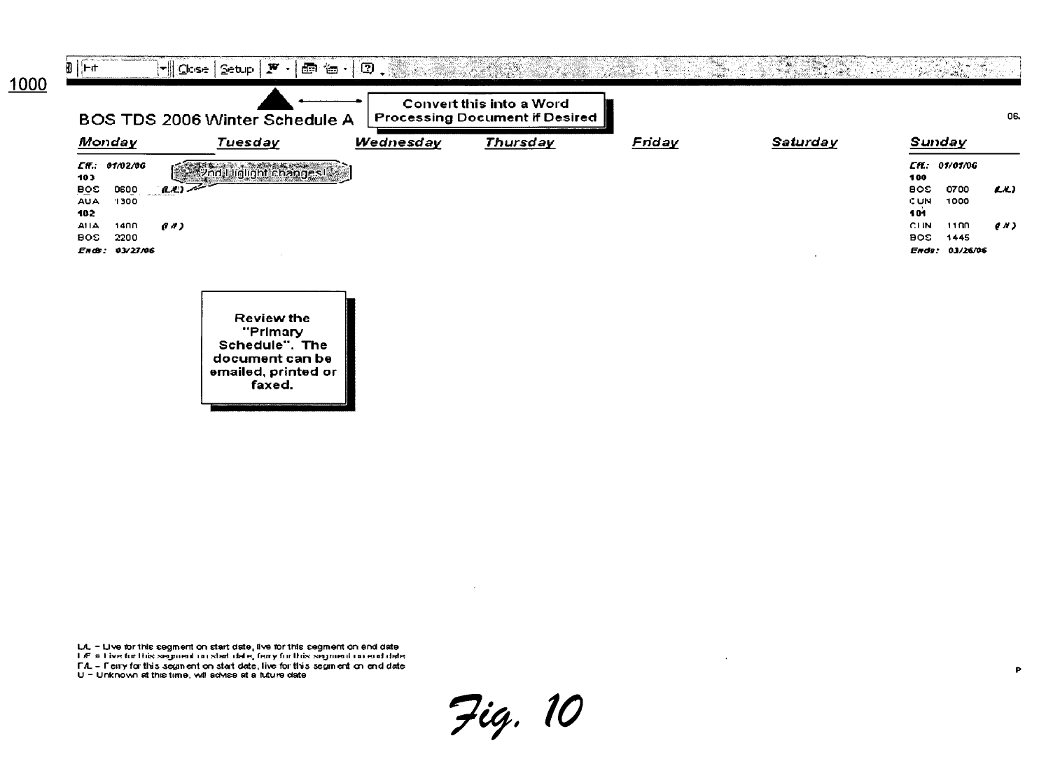

FIG. 10 shows an exemplary primary flight schedule report 1000, according to one embodiment. The data format of this report can be manipulated, imported into a word processing application, edited, highlighted, etc.

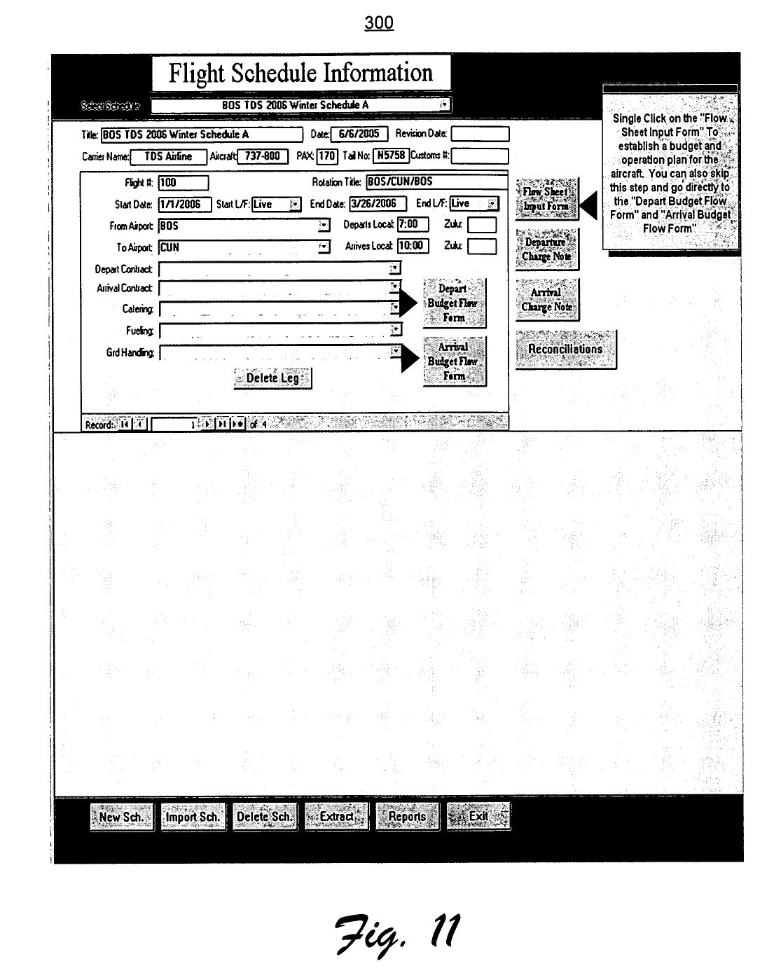

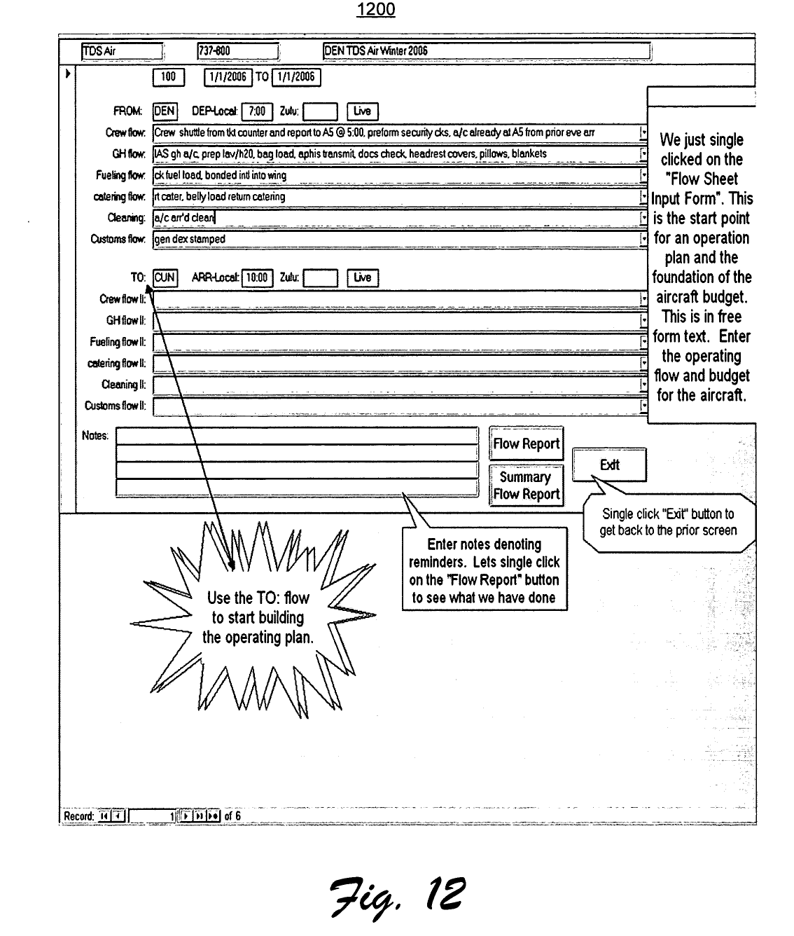

FIG. 11 shows exemplary access to a flow sheet input form UI 1100 from the flight schedule information UI 300, according to one embodiment. The flow sheet input form, which is described below in reference to FIG. 12, allows a user to establish a budget operation plan 120 (e.g., sequences of events) for an aircraft.

FIG. 12 shows an exemplary operational plan input form 1200, according to one embodiment. In this implementation, flight budget module 112 presents operational plan input form 1200 to a user to specify an operation plan 120 based on the flight schedule 118 for turnkey aviation budget management. In this example, the user inputs operational flow information corresponding to the crew, ground handling, fueling, catering, cleaning, customs, etc., for departure and arrival of an aircraft. In this implementation, the user inputs free flow text information. Although the operational flow is shown with respect to flight scheduling, it can be appreciated that operational flow can apply to other aspects of turnkey aviation budget management. For example, in one implementation, operational flow is also provided for one or more of the main menu categories discussed above with respect to FIG. 2.

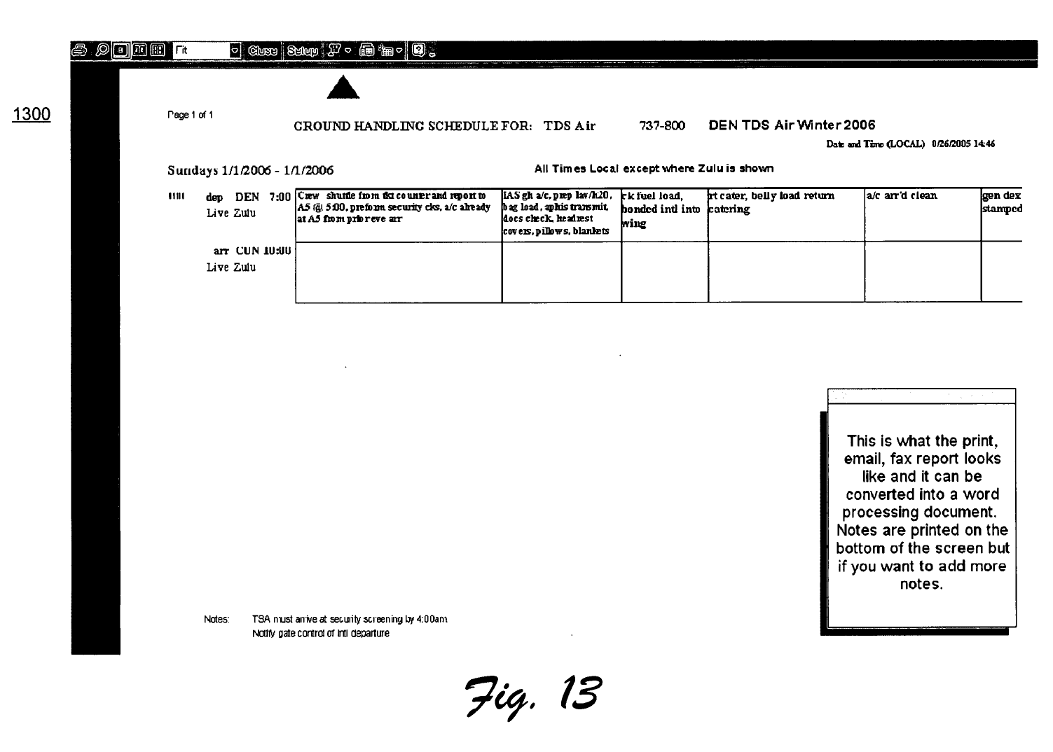

FIG. 13 shows an exemplary flight scheduling report 1300, according to one embodiment. In this implementation, flight scheduling and budget module 112 generates this report from information in operational plan 120. Although the report can pertain to any information in the operational plan 120, in this example, the report pertains to a ground-handling schedule. As discussed above, this report can be printed, e-mailed, faxed, etc., for communication in a concise and timely manner of the reported information to other individuals.

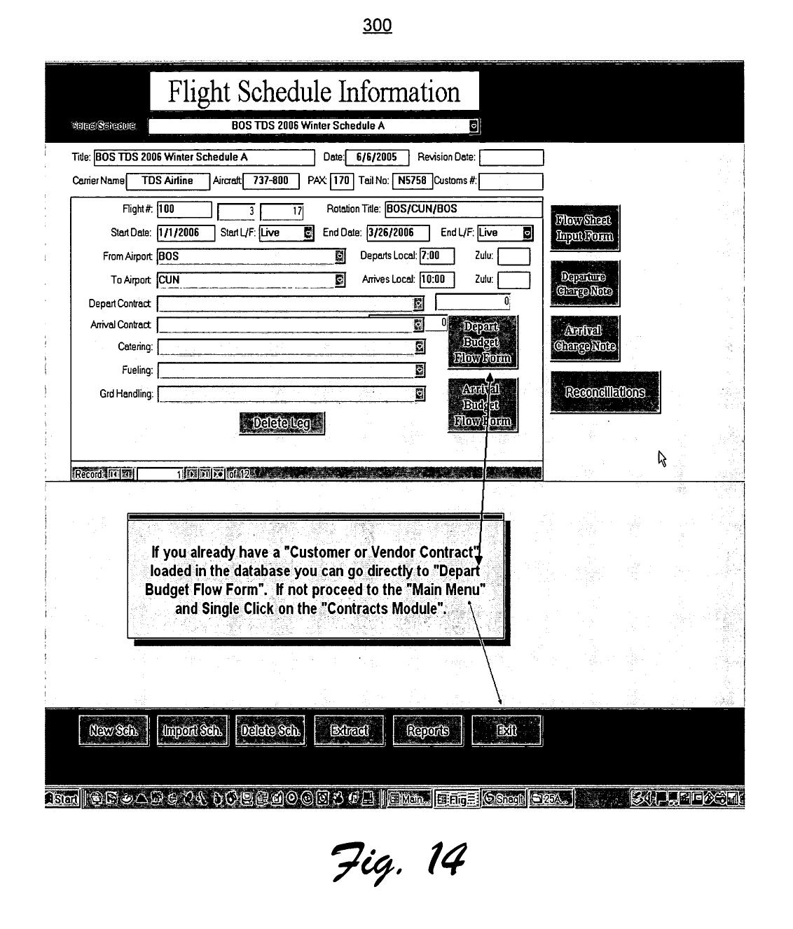

FIG. 14 shows additional aspects of the flight schedule information UI 300 for turnkey aviation budget management. More particularly, the UI of FIG. 14 allows a user to access contract information (e.g., customer, vendor, or other contract information) that has already been loaded into a database or other data storage resource. For purposes of exemplary illustration, such contract information is shown as a respective portion of other data” 128. This contractual information will subsequently be used to associate costs/fees with a budget (i.e., part of the operating plan and budget 120). Pre-existing contract information is available, for example, in the depart and arrival drop-down menus (or other drop-down menus pertaining to crew, security, ground handling, etc.), as shown in greater detail in FIG. 14. Referring to FIG. 14, when such contract information is not pre-existing, the user proceeds to the “Main Menu”, which was described above with respect to FIG. 2, to select the “Contract Module” option to create and specify contract information.

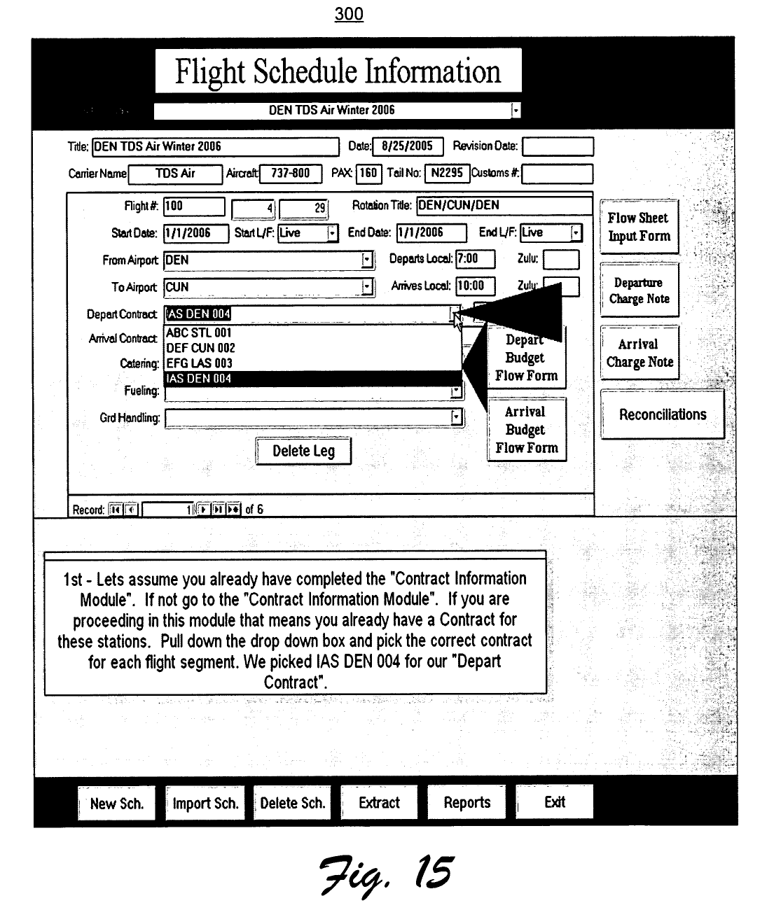

FIG. 15 shows further aspects of the flight schedule information UI 300, according to one embodiment. More particularly, FIG. 15 shows that a UIs with the UI 300 and existing contract information to further specify information for the flight schedule 118. As shown, a user selects the particular contract(s) that pertain to the indicated flight schedule for the indicated airport/station.

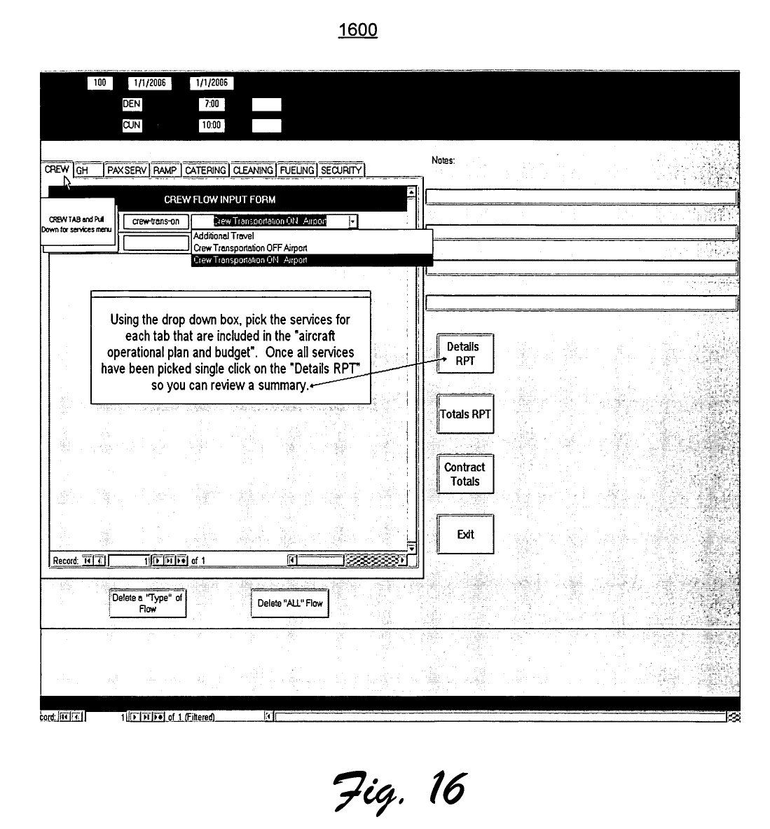

FIG. 16 shows an exemplary UI for inputting various types of flow input into the turnkey aviation budget management system. In this example, the types of flow information (i.e., subject matter possibly associated with cost charges) for input pertain to crew, ground handling, passenger services, ramp, cleaning, fueling, security, etc. The drop-down menus provide the user with additional detailed breakdown of potential charges associated with the selected services. As shown, once services have been selected, a detailed report can be presented to the user via selection of the indicated UI button control.

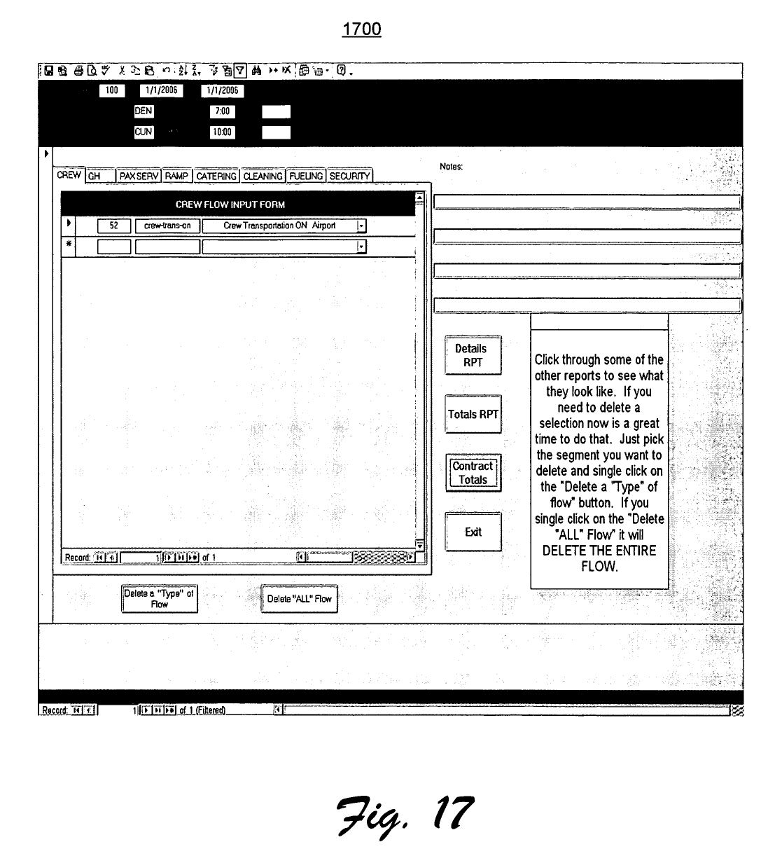

FIG. 17 shows an exemplary UI 1800 showing further aspects of the operational flow input form, according to one embodiment. More particularly, FIG. 17 shows that a user can view the detailed information associated with the specified operational flows 120 in different data views/formats (e.g., details report, totals report, contract totals, etc.). In one implementation, turnkey aviation budget management module 108 exposes an Application Programming Interface (API) 132 allowing for specification of different operational flow report (and other) definitions, formats, etc.

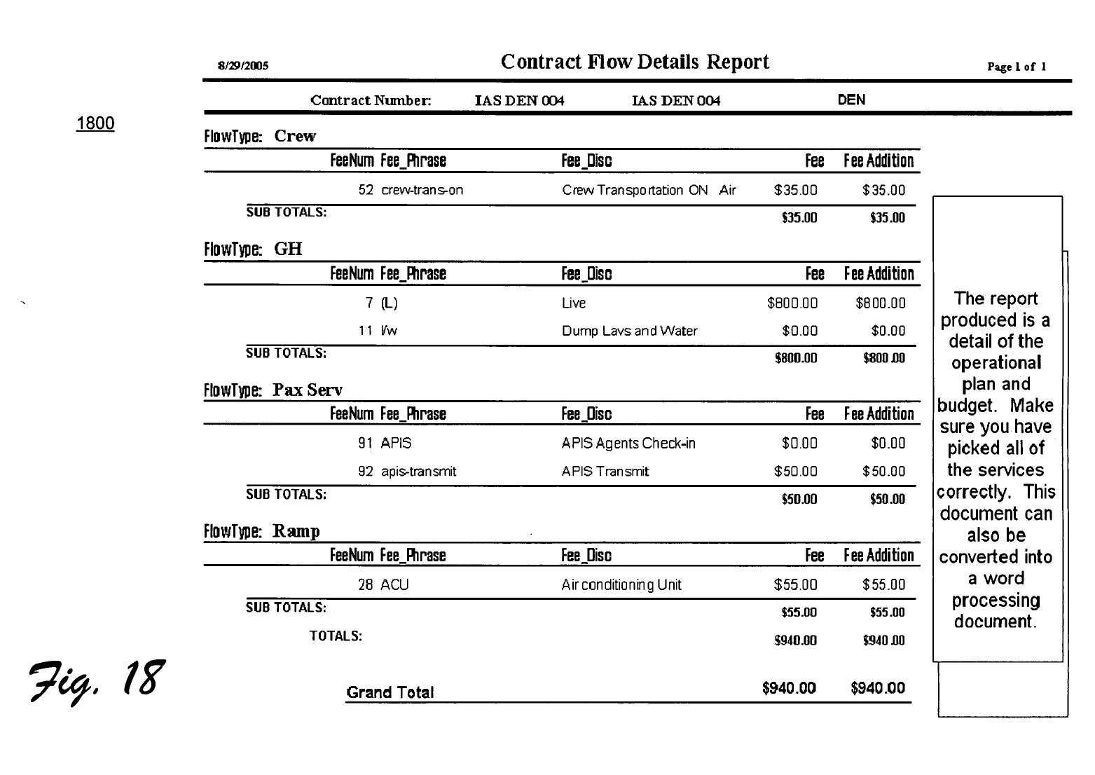

FIG. 18 shows an exemplary contract flow details report 1800, according to one embodiment. This report provides a detailed view of the operational plan and budget.

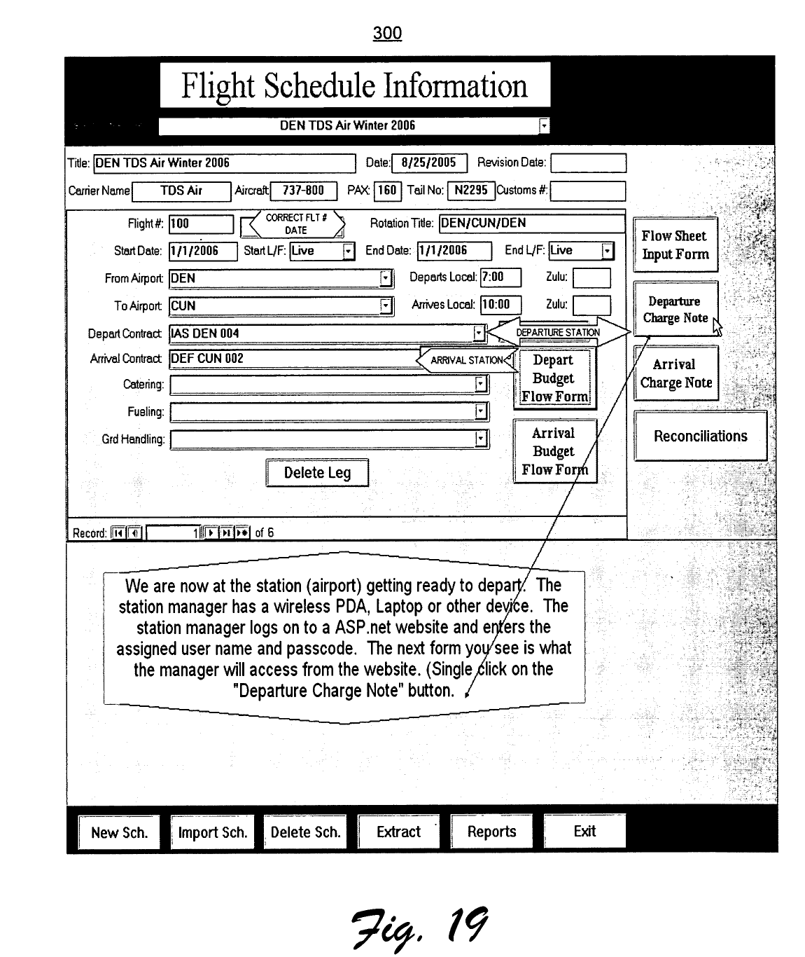

FIG. 19 shows further aspects of the flight schedule information UI 300 for turnkey aviation budget management, according to one embodiment. More particularly, FIG. 18 illustrates that an authorized entity such as a station manager can specify departure charge notes (e.g., respective portion of departure and arrival charge notes 124), indicating substantially all services actually utilized with respect to the aircraft. A user utilizes departure and arrival charge notes to particularly point out activities, services, additional charges, additional manpower used, and other aspects of the aircraft departure and arrival scenario that were not included in the operational plan and budget 120.

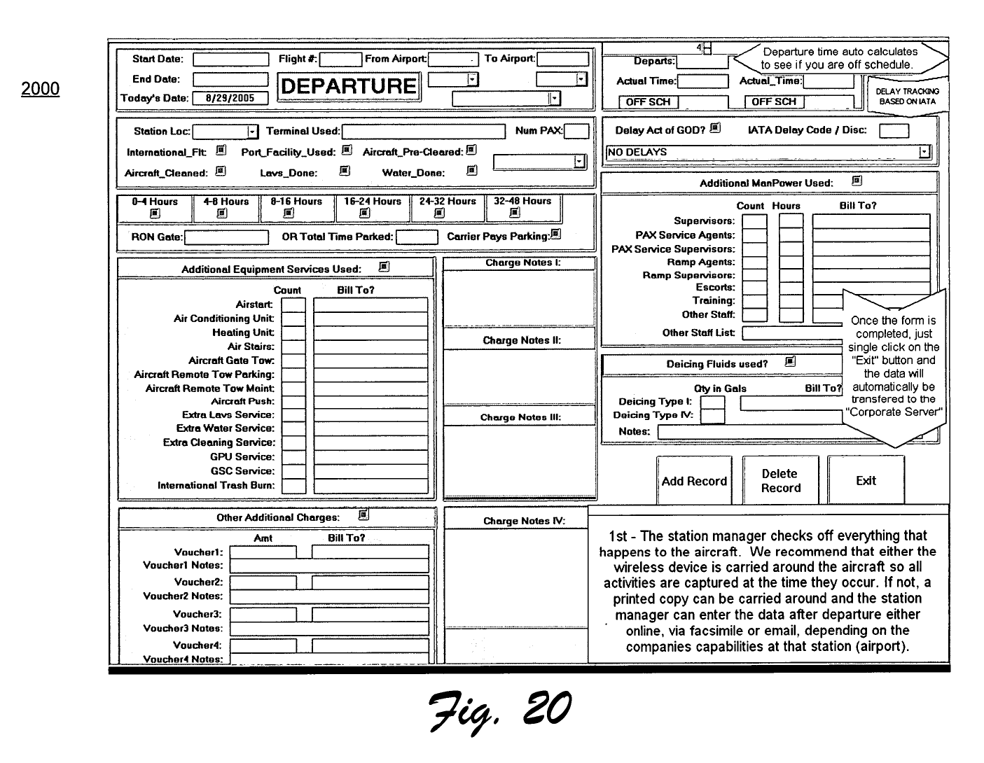

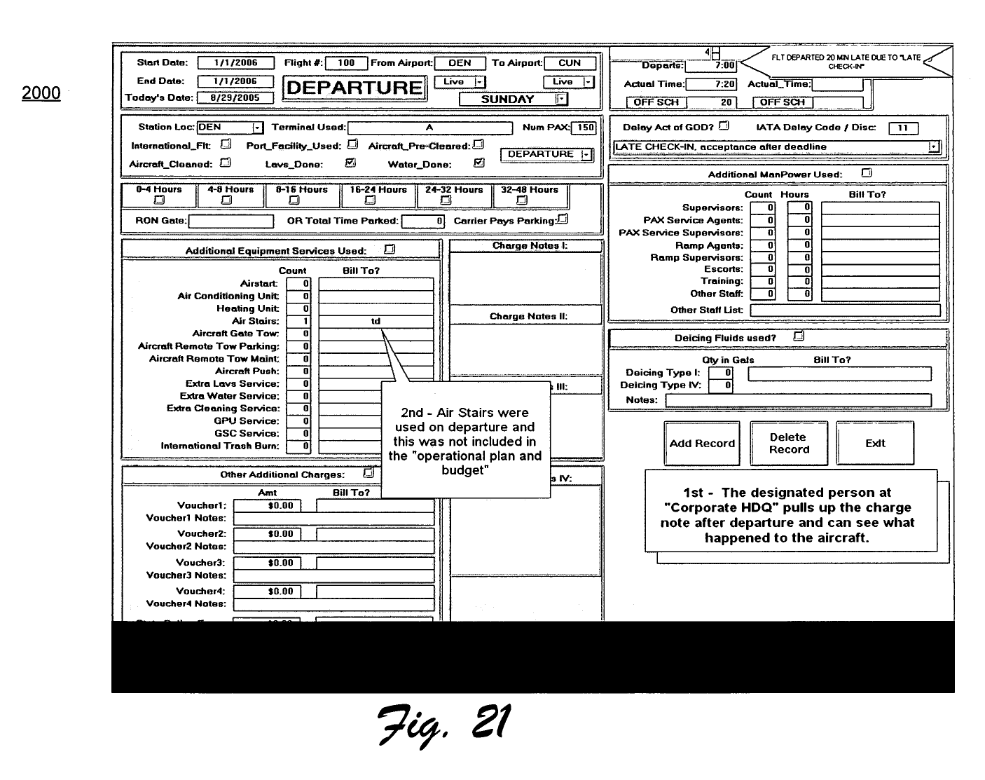

FIGS. 20 and 21 show an exemplary departure charge note UI 2000, according to one embodiment. As described below, aspects of aircraft departure that were not included in the operational plan and budget 120 are utilized by flight budget module 112 for contract and budget reconciliation purposes. The UIs 2000 show, for example, that additional equipment services utilized may pertain to one or more of an air start, air conditioning, heating, stairs, gate tow, water services, etc. In this implementation, additional charges are associated with a corresponding amount, voucher notes, and an indication of an entity considered responsible for the additional charge. The charge note UI also allows the user to indicate an entity to bill for corresponding fees.

In one implementation, a UIs with the charge note UIs 2000 of figs that 20 and 21 via a wireless mobile device (e.g., device 3832 of FIG. 38) to capture activities at the time they occur. In another implementation, a user carries a printed copy of the charge note(s) to manually into the data and subsequently transfer the data after aircraft departure to the operating plan and budget 120. An entity can access the charge notes to determine exactly what additional equipment and services were used with respect to the aircraft. For example, FIG. 21 shows that additional (unplanned) equipment in the form of “air stairs” were required while the aircraft was on the ground. As described below, such additional services and/or recruitment will typically result in unplanned-for fees (i.e., fees not in the operating plan and budget 120).

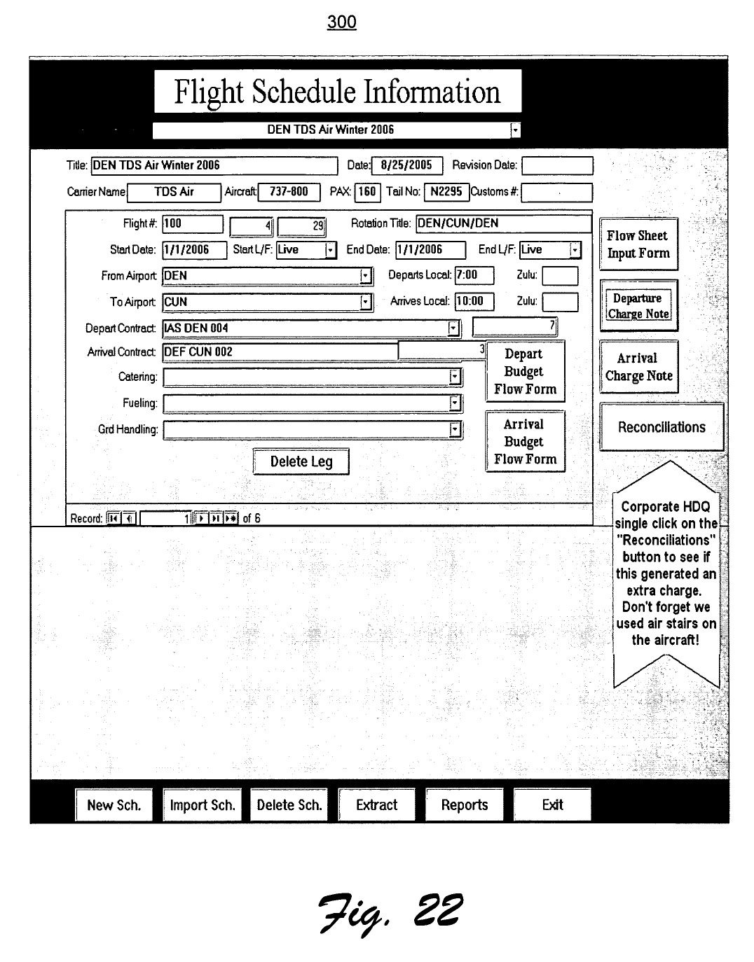

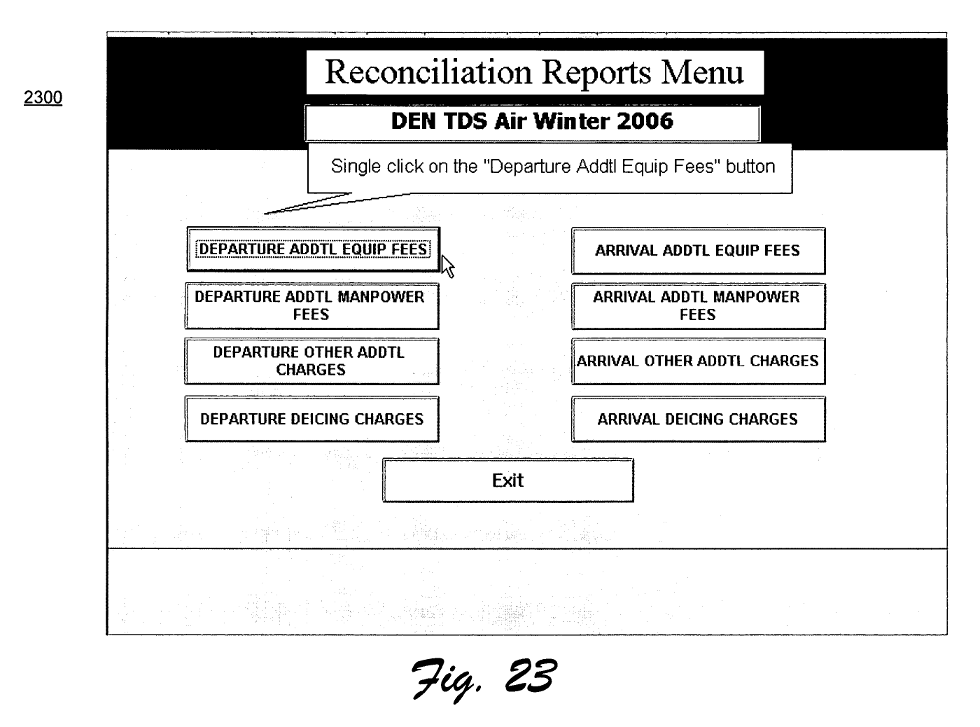

FIG. 22 shows that the flight schedule information UI 300 allows an authorized entity to reconcile departure and arrival charge notes with actual contract information to determine whether the extra operational services/activities have generated additional (previously unaccounted for) charges. A corresponding reconciliation reports menu is displayed, as described below in reference to FIG. 23.

FIG. 23 shows an exemplary reconciliation reports menu 2300 UI, according to one embodiment. As shown, this configurable UI allows a user to generate real-time (i.e. timely) departure and arrival cost reconciliation reports for the specified flight schedule. The departure and arrival cost reconciliation reports include, for example, reports showing any additional equipment fees, additional manpower fees, other additional charges, deicing charges, etc. Any such additional fees/charges were not originally considered in the operating plan and budget 120.

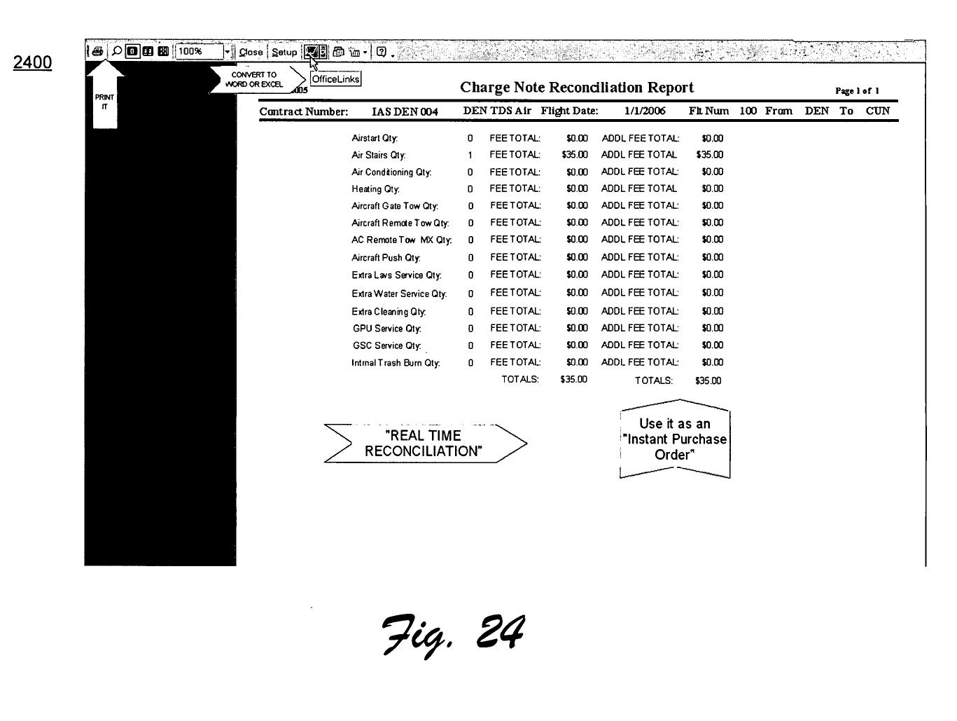

FIG. 24 shows an exemplary charge note reconciliation report 2400, according to one embodiment. In this example, the report shows that an extra $35 fee was charged for air stairs. Please note that this extra equipment was pointed out in the departure charge not of FIG. 20. In one implementation, the charge note reconciliation report is used as a purchase order. In another implementation, the charge note reconciliation report includes additional information such as a signature line allowing an authorized individual to sign off on the additional charge, and/or indicate the individual/entity responsible for the charge.

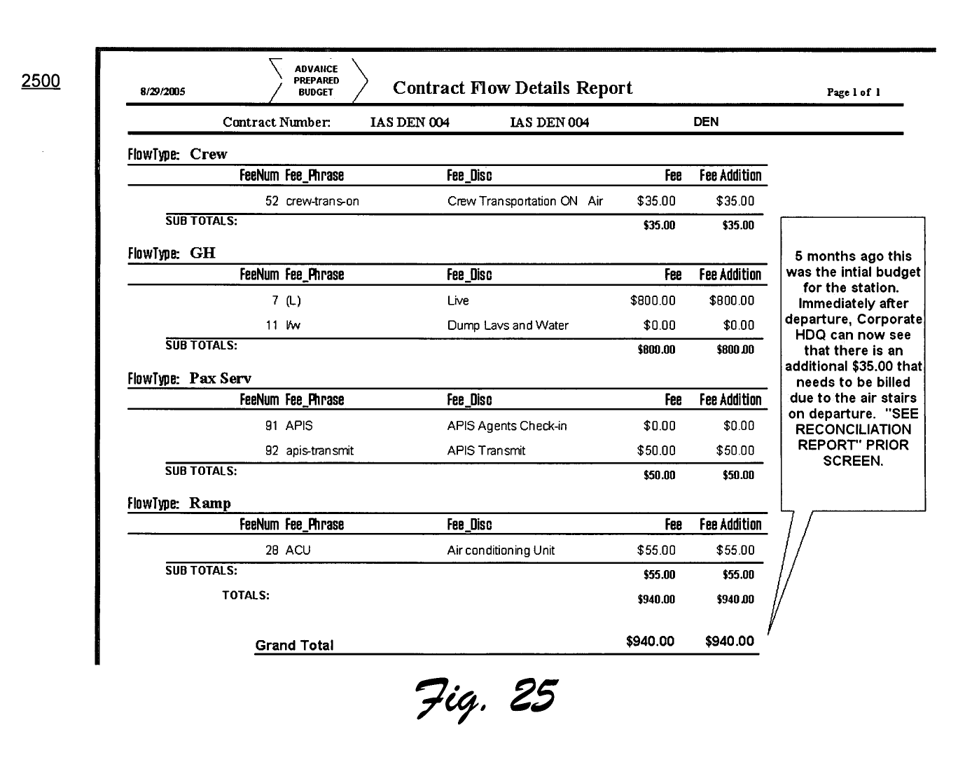

FIG. 25 shows an exemplary contract flow details report 2500, according to one embodiment. The contract flow details report shows the initial fees associated with the operational plan and budget 120.

### Expectation Fees

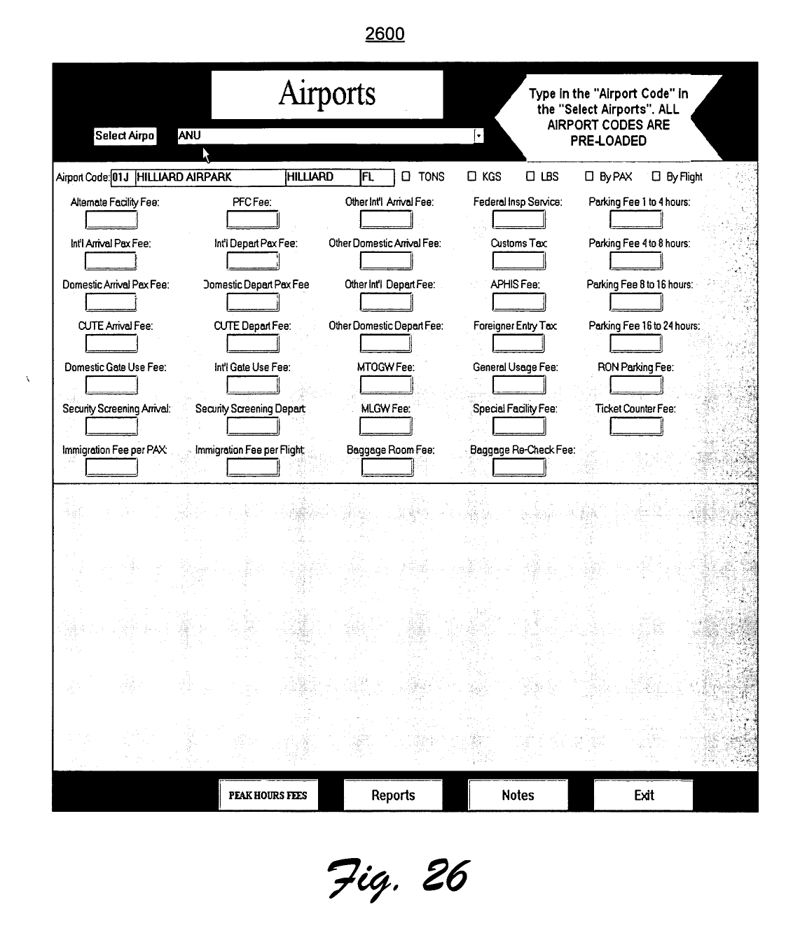

In this implementation, airport module 114 of FIG. 1 displays respective UIs of FIGS. 26 through 29 to gather airport fee information, airport notes, and generate corresponding reports. However, the UIs of FIGS. 26 through 29 are exemplary UIs that illustrate the type of UI that an airport or any other entity that assesses fees in the aviation industry would utilize to present corresponding fees, and notes, and generate reports. For example, airlines, service providers, and equipment or product providers could also implement and customize these UIs to specify, generate, and present fees, as well as produce reports associated with their respective operations. Thus, the particular layout and labeling of the following described UIs is arbitrary and is based on the origin of the specified aviation-based fees and corresponding reports.

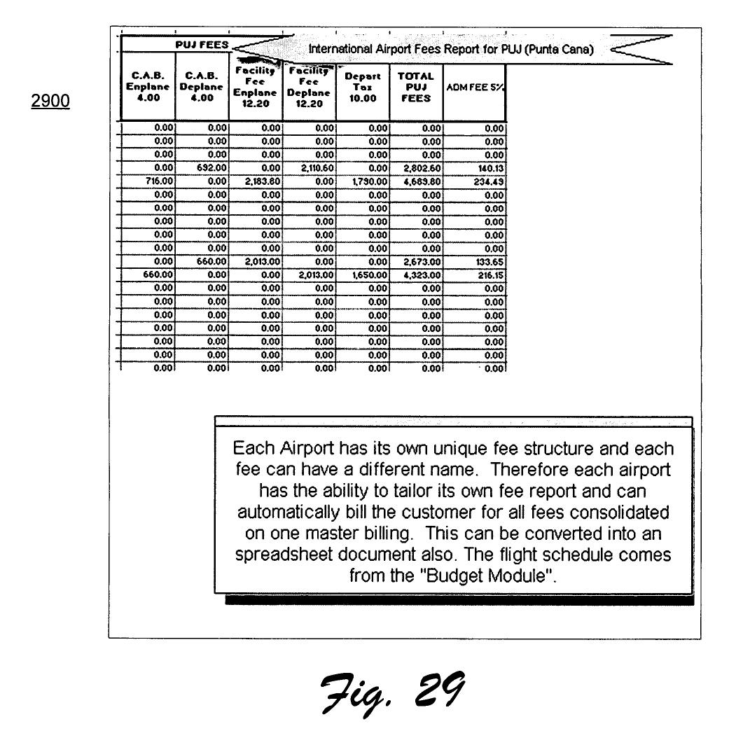

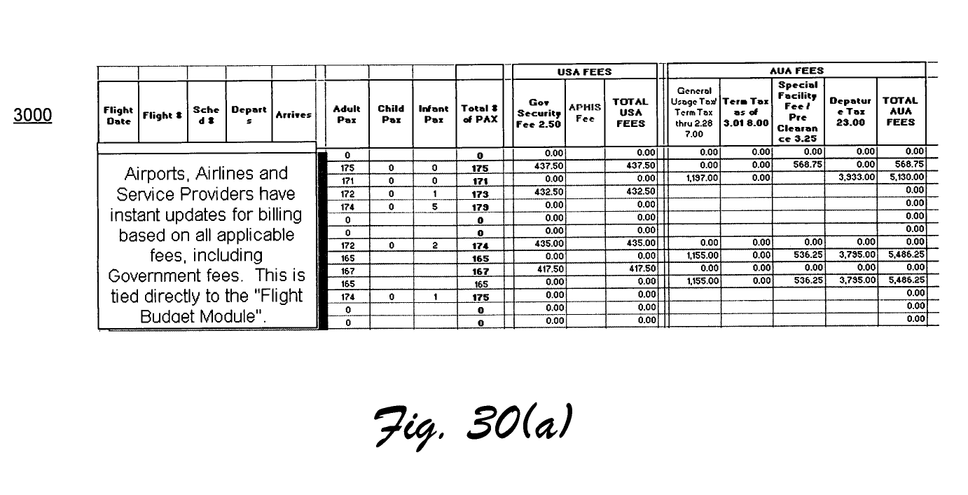

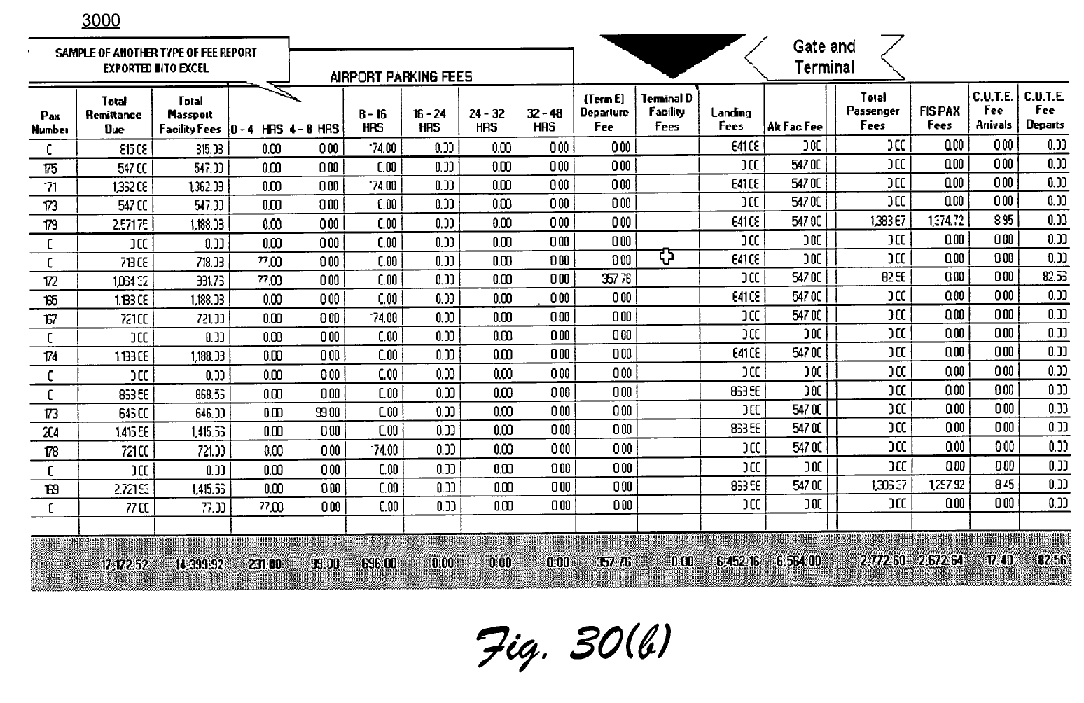

FIG. 26 shows exemplary airports fees UI 2600, according to one embodiment. Airports module 114 (FIG. 1) utilizes UI 2600 to specify and list fees associated with a particular airport, including terminal fees. Each airport typically has its own unique fee structure and fee definitions. Thus, each airport can utilize UI 2600 to tailor its own fee report (please see FIG. 29). As shown below in reference to FIG. 30, such a fee report can be mapped to a flight schedule 118 and operational plan 120 to indicate how much a particular customer (e.g., airline) owes the airport. Referring to FIG. 26, the various fees are configurable. In one implementation, these fees also include one or more fees associated with facilities, landing, baggage, carousel, equipment, and/or so on.

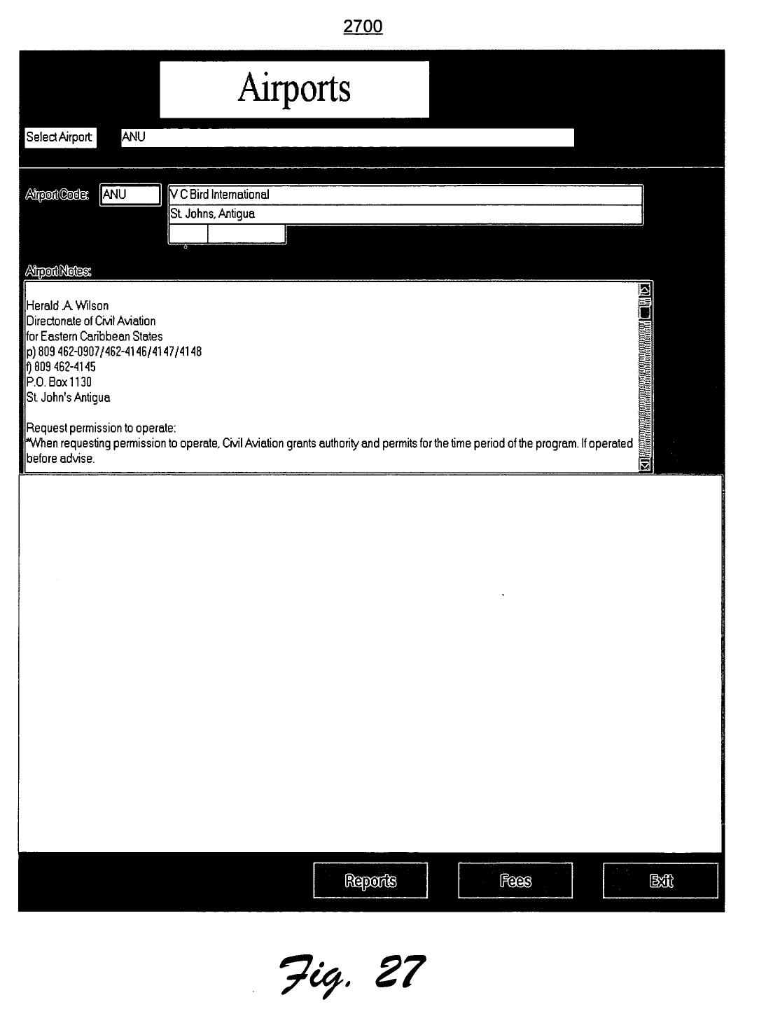

FIG. 27 shows exemplary aspects of an airport notes UI 2700, according to one embodiment. UI 2700 provides a central location to specify and identify airport and contact information. In this implementation, airport information includes, for example, indications of how to request permission to operate; who to send requests to in customs, immigration, agriculture, etc; restrictions; black out times; civil aviation contacts; gating contacts; indications of when certain activities can take place (e.g., taxi times, etc.); etc. In this implementation, a user inputs this information for storage and subsequent retrieval to/from one or more of a local and remote data storage device.

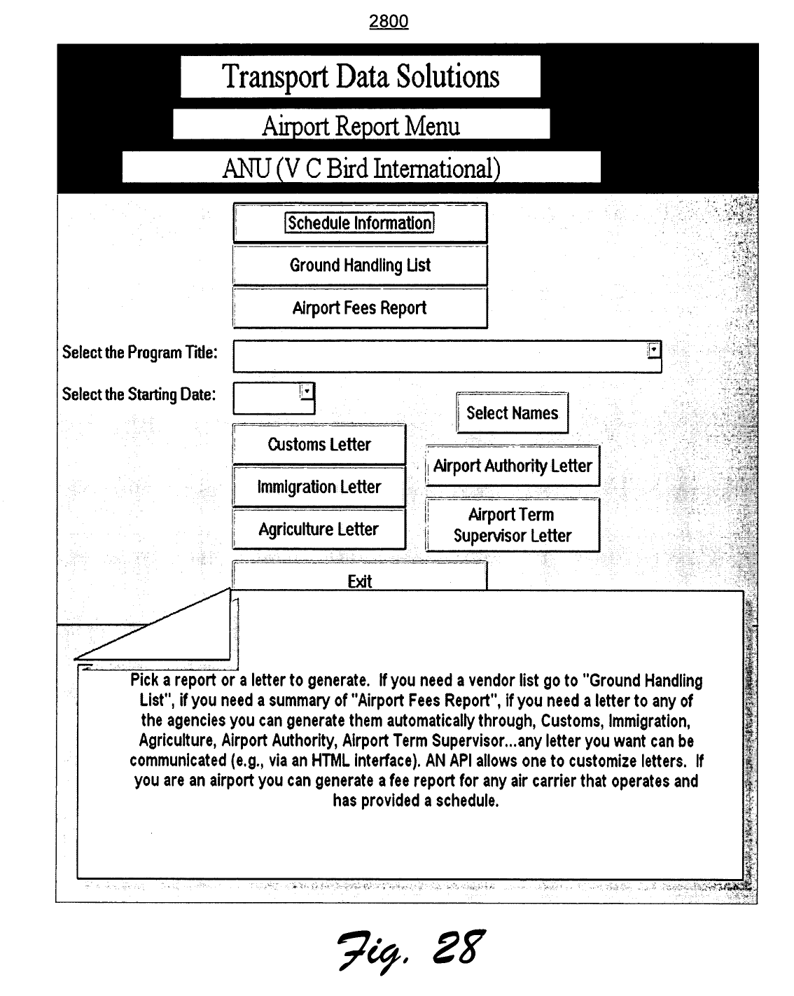

FIG. 28 shows an exemplary airport report menu UI 2800, according to one embodiment. Airports module 114 (FIG. 1) presents UI 2800 to allow a user to generate various types of reports (i.e., respective portions of generated aviation budget management reports 122 of FIG. 1). In one implementation, these reports include one or more reports based on schedule information (the flight schedule 118) and the airline operating plan (operating plan 120), ground handling, airport fees (please see FIGS. 26, 29, and 30), etc. In this implementation, UI 2800 also allows a user to automatically generate communications such as letters to respective entities (e.g., customs, immigration, agriculture, airport authority, airport supervisor, etc.). These various letters will include fee and possibly other information such as scheduling information, timing, passenger information, cargo information, etc. The types, formats, and recipients of such letters are customizable using supplied report and/or letter templates (please see respective portions of “other data” 128). In one implementation, the types, formats, and recipients of such letters are programmatically customizable, for example, through API 130 of FIG. 1.

FIG. 29 shows in exemplary airport fees report 2900, according to one embodiment.

FIG. 30 shows an exemplary airport fees report 3000 incorporating an aircraft flight schedule 118 and operating plan 120, according to one embodiment.

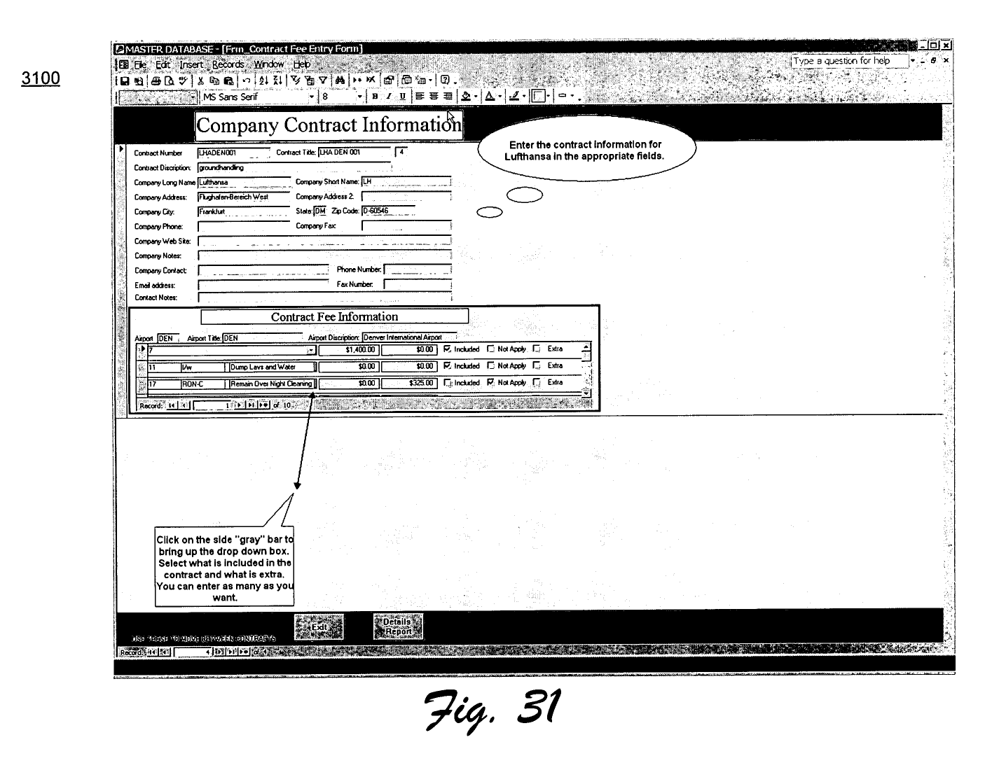

FIG. 31 shows an exemplary company contract information UI 3100 to specify contract specifics including contract fee information, according to one embodiment. A user accesses UI 3100 by selecting the “Contract Information” UI Control from the main menu of FIG. 2. UI 3100 allows a user to create and specify specific contractual information for use by flight scheduling and budget module 112 to reconcile fees, once they have been assessed, with a defined operating plan and budget 120 (FIG. 1), and thereby, identify any access fees that are over budget. For purposes of exemplary illustration, contracts are shown as a respective portion of “other data” 128 of FIG. 1. The actual type, details, and content of any particular contract is arbitrary and as a function of the particular contract between two or more entities. Turnkey aviation budget management module 108 allows a user to customize aspects of a contract by importing a contract template or programmatically through API 130.

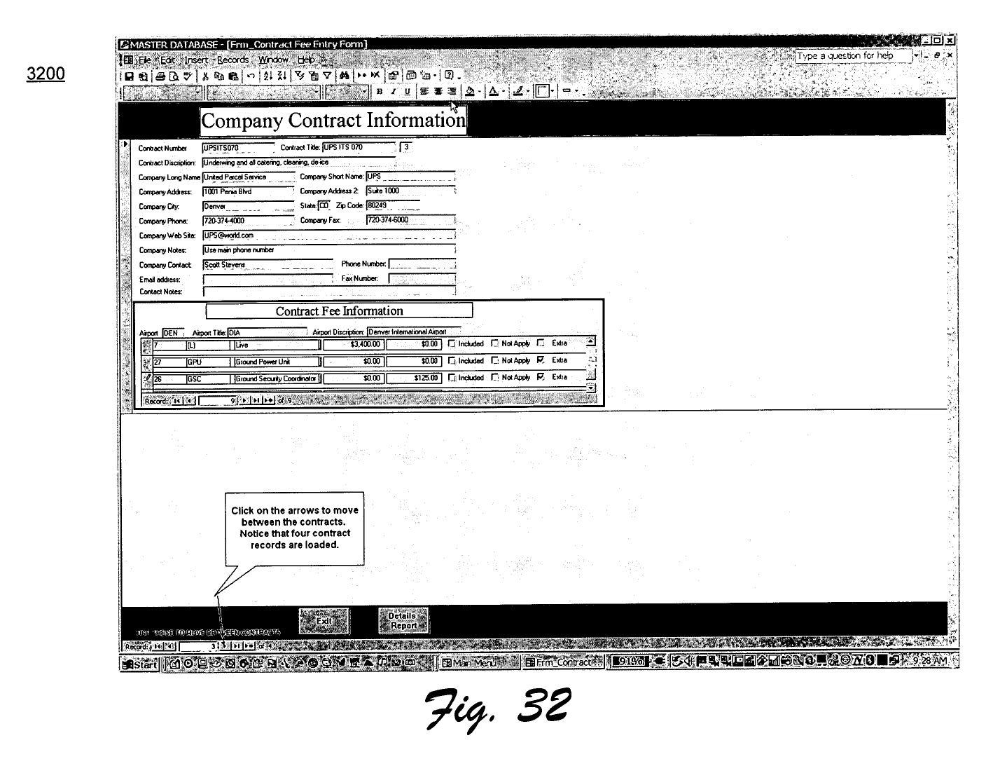

FIG. 32 shows further exemplary aspects of the company contract information 3100 of FIG. 31, according to one embodiment. More particularly, FIG. 32 shows that a user can select a UI control (e.g., an arrow control) to move between contract records and respective contracts.

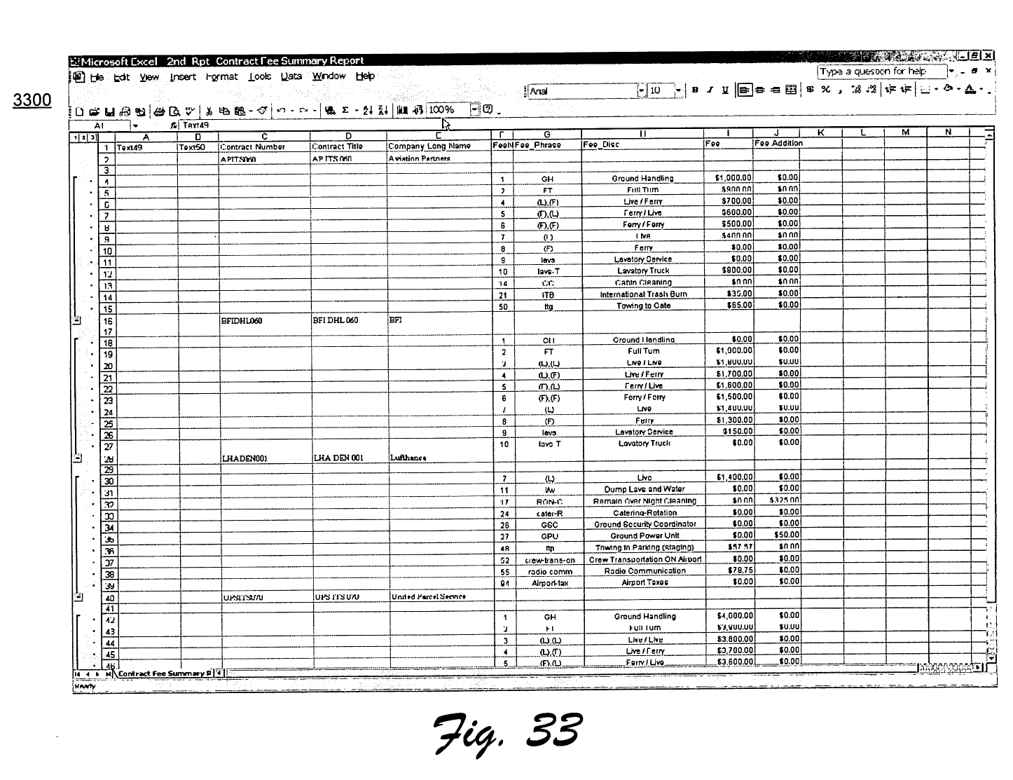

FIG. 33 shows an exemplary contract fee details report 3300, according to one embodiment. A user generates reports 3300 by selecting the “General Reports” button control of FIG. 2.

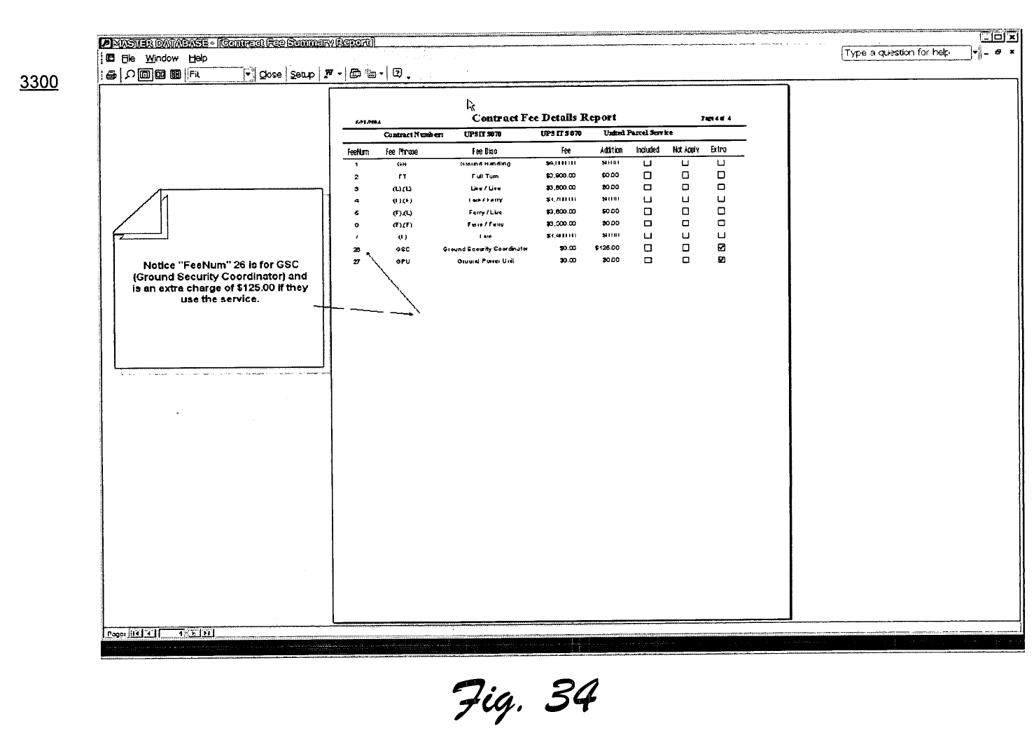

FIG. 34 shows further aspects of the exemplary contract fee details report 3300 of FIG. 33, according to one embodiment. More particularly, FIG. 34 shows that under certain conditions, an entity bound to the contract will be charged an extra fee.

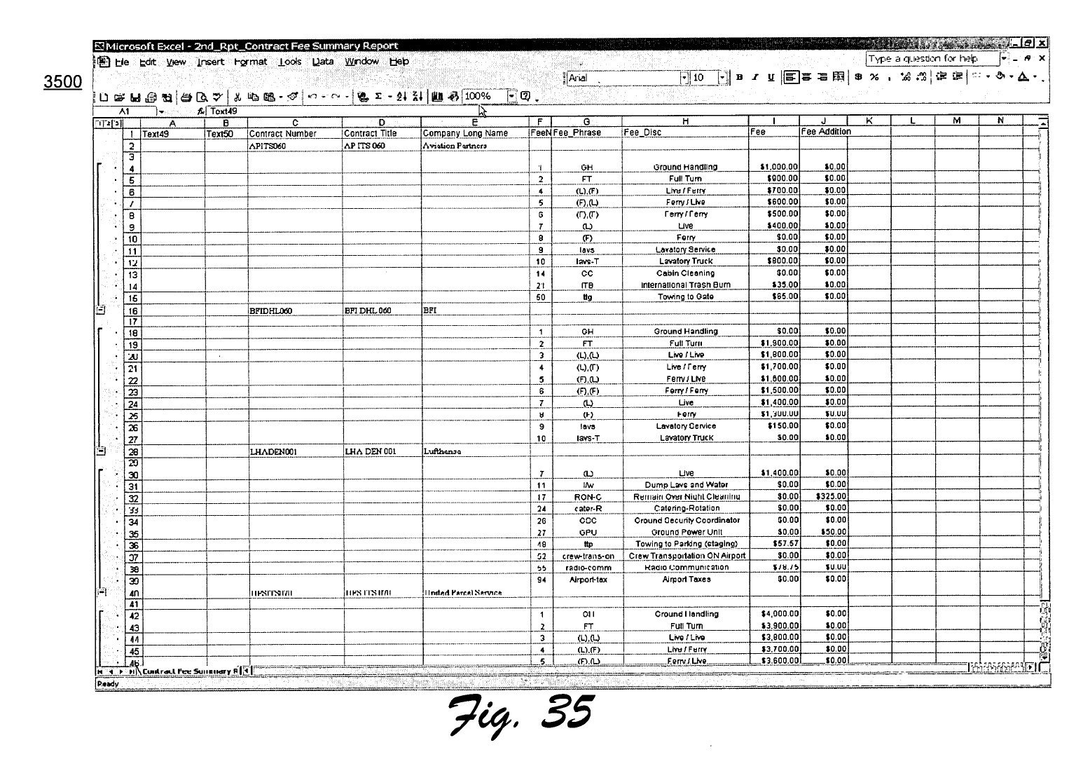

FIG. 35 shows exemplary aspects of a contract fee summary report 3500, according to one implementation. This report 3500 provides various details of contracts including, for example, contract number, title, company name, the types, fees, additional fees, etc. Flight scheduling and budget module 112 utilizes information associated with this report to create a budget 120 and to reconcile the budget with actually assessed fees.

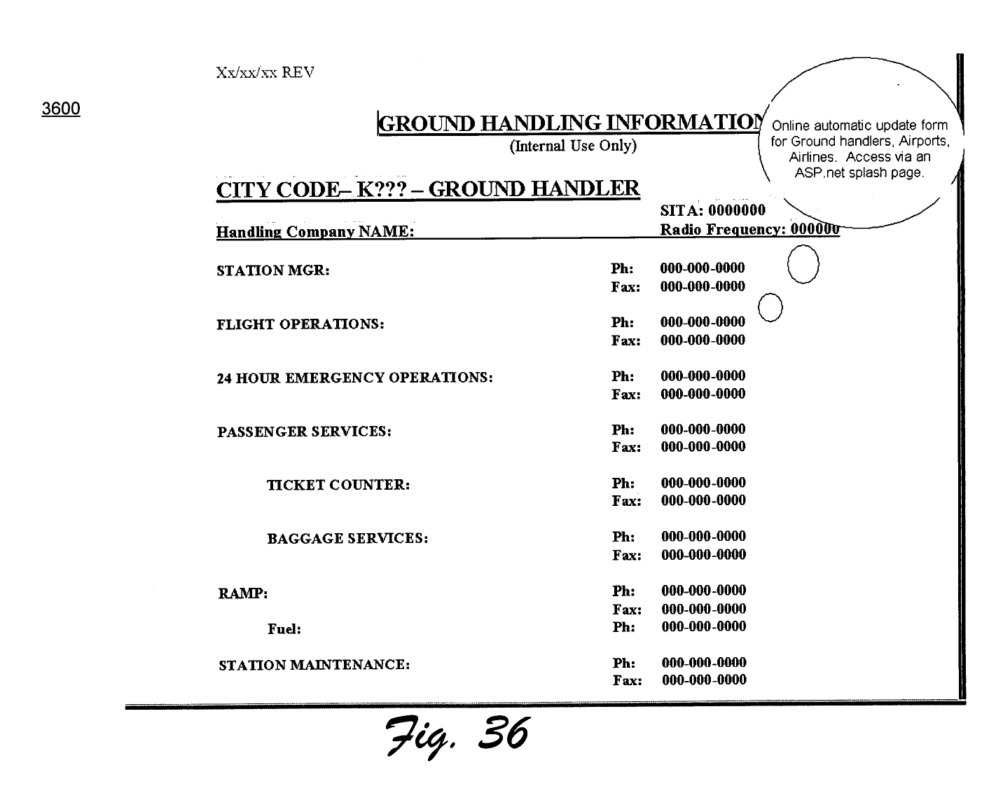

FIG. 36 shows an exemplary entity information update form or web page for an entity to provide information useful to turnkey aviation budget management, according to one embodiment. In this example, the update form pertains to ground handling information. However, such update forms can be generated for presentation to any service provider, equipment provider, product provider, airport, airline, etc., that is useful for turnkey aviation budget management.

An Exemplary Networked Operating Environment

FIG. 38 illustrates an example of a suitable computing environment 3800 in which turnkey aviation budget management of system 100 of FIG. 1 may be fully or partially implemented. For purposes of exemplary illustration and discussion, aspects, components, and operations of FIG. 38 are described with respect to aspects, components, and operations of FIG. 1. The leftmost digit of a component reference number indicates the figure where the component was first described.

Exemplary computing environment 3800 is only one example of a suitable computing environment for implementing computer-program modules for implementing the apparatus and methodologies of computing device 102 of FIG. 1, and is not intended to suggest any limitation as to the scope of use or functionality of systems and methods the described herein. Neither should computing environment 3800 be interpreted as having any dependency or requirement relating to any one or combination of components illustrated in computing environment 3800.

Computing environment 3800 includes, for example, central trusted server 3802 coupled across a communication network 3804 to an airline server 3806, an airport server 3808, and one or more service/equipment provider servers 3810. In this implementation, central trusted server 3802 includes turnkey aviation budget management computer-program module 3812 and web server 3814. Turnkey aviation budget management module 3812 includes computer-program instructions executable by a processor to implement at least a subset of the operations described above with respect to turnkey aviation budget management module 108 of FIG. 1. Responsive to receiving specific requests from one or more of airline server 3806, airport server 3808, and/or service/equipment provider server 3810, turnkey aviation budget management module 3812 communicates corresponding information to the requesting server(s).

### Flight Schedules, Operating Plans, and Airline Specific Reports

Responsive to a request from airline server 3806, central server 3802 allows the airline server 3806 to generate a flight schedule 3816, an operating plan and budget 3818, generate airline specific reports 3820 (e.g., please see FIGS. 9 and 10). For purposes of exemplary illustration, airline specific reports 3820 include one or more of airline departure and arrival charge notes (e.g., charge notes 124 of FIG. 1). Other such reports include, for example, reports that reconcile the budget 3818 with actual fees assessed by an airport and/or service/equipment providers. To accomplish this, central server 3802 communicates UIs and the information to airline server 3806. Such UIs are described above with respect to FIGS. 2 through 24. Central server 3800 utilizes web server 3814 to serve respective ones of the UIs to the airline server 3806 as web pages. Such fee information includes, for example, airport fee data 3822 for a particular and/or service/equipment provider fee data 3824 for specific providers. In one implementation, the request identifies the particular airport and specific providers. Flight schedule 3816, operating plan and budget of 3818, airport fee data 3822, and service/equipment provider fee data 3824 are respective analogues of flight schedule 118 (FIG. 1), operating plan and budget 120, and at least a subset of fee data 126.

Responsive to generating airline flight schedule 3816, operating plan and budget 3818, and departure and arrival charge notes, airline server 3806 communicates data 3819 to the central server 3802. Data 3819 includes, for example, the airline flight schedule 3816, operating plan portions of the operating plan and budget of 3818, and the departure and arrival charge notes to the central server 3802 for storage and communication to other requesting entities (e.g., as described below: airport server 3808 to generate airport fee data 3822 and airport specific reports 3828, service/equipment provider server 3810 to generate service/equipment provider fee data 3824 and service/equipment provider specific reports 3830). For purposes of exemplary illustration, respective portions of program data 3826 represent one or more airline flight schedules from respective airlines (e.g., airline flight schedule 3816).

Responsive to receiving, by the airline server 3806, this information from the central server 3802, a user of the airline server interacts with the communicated UIs to generate the airline flight schedule 3816, the operational plan and budget 3818, and generate and present one or more airline specific reports 3820.

Airline server 3806, responsive to receiving a request for airline arrival and/or departure charge notes from a computing device (e.g., handheld computing device 3832), airline server 3806 communicates the requested charge notes (e.g., charge notes 3834) to the requesting device. In this implementation, a user of handheld 3832 uses the communicated charge notes to identify essentially all activities (and associated information) that occur with respect to an aircraft on the ground at an airport. Once these actual charges have been noted, the user directs device 3832 to communicate the completed charge notes 3834 back to the airline server.

### Airport Fees, Budgets, and Airport Specific Reports

Central server 3802, responsive to receiving a request from airport server 3808, communicates information to the airport server 3808 to allow an entity using the airport server 3808 to create and manage airport fee data 3822 and generate and present airport specific reports 3828 (e.g., budget reconciliation reports, etc.). Analogous to how the airline server reconciles the budget 3820 with actual assessed fees, these airport specific reports allow the airport to track airline gating information, and reconcile airport budgets 3836 with actual assessed fees. Such communicated information includes, for example, flight schedule and operating plan information for a specific airline. In one implementation, the request received from the airport server 3808 specifies the particular airline. For example, central server 3802 serves web pages corresponding to respective ones of FIGS. 26 through 31 and 32 through 37 (contract creation and management UIs) to the airport server for presentation to a user, allowing the user to create and manage contracts between the particular airline and the corresponding airport, generate airport fee data 3822, and airport specific reports 3828. The airport server 3808 communicates the airport fee data 3822 to the central server 3802 for subsequent uploading by airline server 3806. As described above, the airline server 3806 uploads airport fee data 3822 for a requested airport to create the budget 3818.

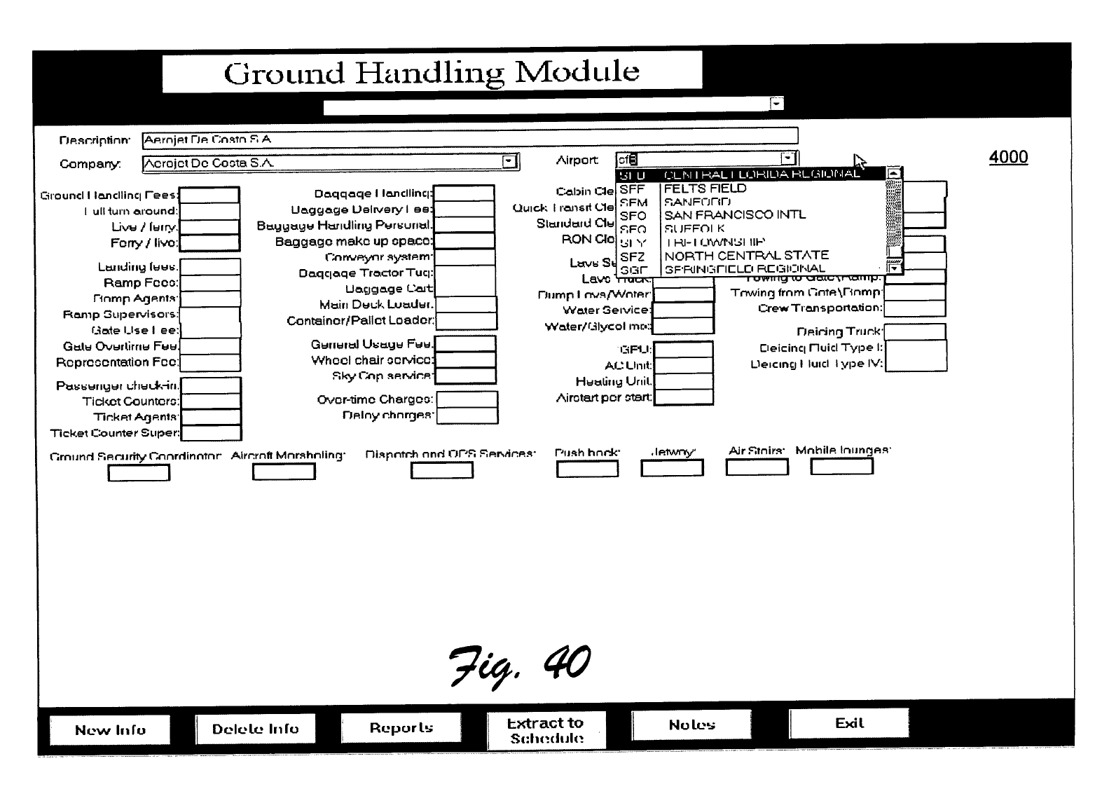

FIG. 40 shows an exemplary airport gate chart 4000, according to one embodiment.

### Service/Equipment Provider Fees, Budgets, and Specific Reports

Central server 3802, responsive to receiving a request from service/equipment provider server 3810, communicates information to the requesting server to allow the requesting server to generate a budget 3838, service/equipment provider fee data 3824, and service/equipment provider specific reports 3830 (e.g., budget reconciliation reports, etc.). Analogous to how the airline server reconciles the budget 3820 with actual assessed fees, these service/equipment provider specific reports allow the provider to track equipment, manpower, etc., and reconcile the generated budget 3838 with actual assessed fees. Such communicated information includes, for example, flight schedule and operating plan information for a specific airline, and one or more UIs allowing the provider to specify contractual information, create a fee list, generated budget, and reconcile actually accrued fees with the budget to identify any over-budget costs. For example, central server 3802 serves web pages corresponding to respective ones of FIGS. 26 through 31 and 32 through 37 (contract creation and management UIs) to the provider server 3810 for presentation to a user, allowing the user to create and manage contracts between a particular airline and the provider, generate service/equipment provider fee data 3824, and service/equipment provider specific reports 3830. The provider server 3810 communicates the service/equipment provider specific fee data 3824 to the central server 3802 for subsequent access by airline server 3806. For instance, and as described above, airline server 3806 uploads service/equipment provider fee data 3824 for a requested provider to create a budget 3818.

FIG. 40 shows an exemplary service provider report 4000, according to one embodiment. More particularly, report 4000 shows an exemplary ground handling module report.

Referring to FIG. 38, and although FIG. 38 has been described with respect to an airline assessing over budget expenses and leveraging those assessments in one or more of multiple ways (e.g., reports, purchase orders, etc.), it can be appreciated that other entities besides an airline can use system 100 to perform analogous operations for turnkey aviation budget management. For instance, system 100 allows other entities such as airports, service providers (ground handlers etc.), equipment and product providers, and/or any other entity that has generated a budget in view of fee expectations associated with a flight schedule, to generate respective charge notes (e.g., aircraft departure and arrival charge notes, ground handling charge notes, deicing charge notes, etc.) to identify fees actually assessed; and, reconcile the actual assessed fees with the budget to determine over-budget expenses; identify one or more entities responsible for over-budget expenses; automatically generate purchase orders for the over-budget expenses; and/or so on.

For instance, in one exemplary implementation, turnkey aviation budget management logic is distributed across servers and central server 3802 is repository for one or more airline flight schedules 3816 and corresponding plan portions of operating plans and budgets 3818, airport fee data 3822, and service/equipment provider fee data 3824. In this implementation, for example, airline server 3806 implements at least computer-program logic for flight scheduling and budgeting (e.g., see flight scheduling and budget module 112 FIG. 1). In another implementation, when an airline associated with airline server 3806 desires to perform one or more services typically provided by a service/equipment provider, airline server 3806 also implements one or more service/equipment provider modules (e.g., respective plug-in modules for the respective services been implemented by the airline; please see service/equipment provider module 116 of FIG. 1). Analogously, when the airline desires to lease and control their own gates, respective portions of airports motto 114 of FIG. 1 to generate airport specific fee data are also implemented by airline server 3806.

In one implementation, airport server 3808 implements computer-program logic for creating and managing contracts between the associated airport and the airline. This contract logic presents respective ones of the UIs associated with FIGS. 32 through 37 for contact contract creation and management. Additionally, the airport server implements logic analogous to airport module 114 of FIG. 1 to specify airport specific fee information for distribution to one or more of the airline server 3806 and service/equipment provider servers 3810. For instance, this fee information is distributed to central server 3802 for subsequent distribution to one or more of airline server 3806 and airport server 3808.

In one implementation, service/equipment provider 3810 implements computer-program logic for creating and managing contracts between an airline and the provider. This contract logic presents respective ones of the UIs associated with FIGS. 32 through 37 for contact contract creation and management. Additionally, the provider server implements: budget creation and management logic analogous to that implemented by flight scheduling and budget module 112 (i.e., without the flight scheduling portion of the logic); and fee specification logic analogous to that implemented by airport module 114 of FIG. 1 (with the exception that the logic is specific to the type of services/equipment associated with the provider) to specify service/equipment provider specific fees in view of the contracts. As described above, this fee information is distributed to a central server 3802 for subsequent distribution to one or more of airline server 3806 and airport server 3808.

Exemplary Procedures

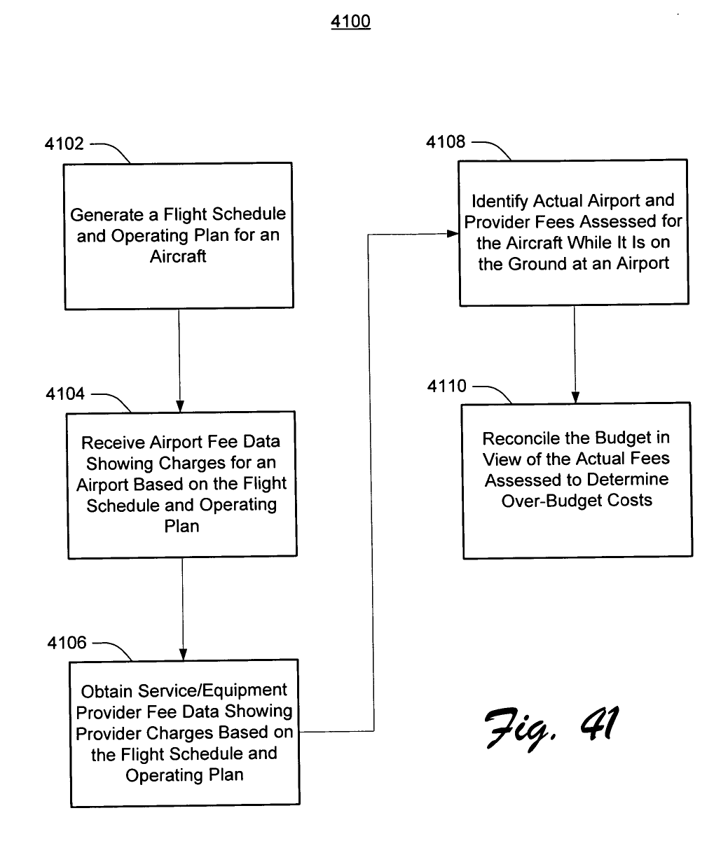

FIG. 41 shows an exemplary procedure 4100 for aviation budget management, according to one embodiment. More particularly, procedure 4100 shows how an airline reconciles costs actually assessed while in aircraft is on the ground at an airport (between landing and takeoff) with a predetermined budget that takes into account airport and service/equipment provider fees. For purposes of exemplary discussion, the operations of procedure 4100 are described in reference to the components of FIG. 1.

At block 4102, turnkey aviation budget management module 108 (FIG. 1) generates a flight schedule 118 and operating plan 120 for an aircraft. At block 4104, turnkey aviation budget management module 108 receives airport fee data 126 for an airport based on the flight schedule 118 and operating plan 120. At block 4106, turnkey aviation budget management module 108 obtains service/equipment provider fee data 126 showing provider charges based on the flight schedule 118 and operating plan 120. At block 4108, turnkey aviation budget management module 108 determines actual fees assessed by the airport and/or by one or more service/providers while the aircraft was on the ground at the airport. At block 4110, turnkey aviation budget management module 108 reconciles the budget 120 in view of the actual fees assessed to determine over-budget costs.

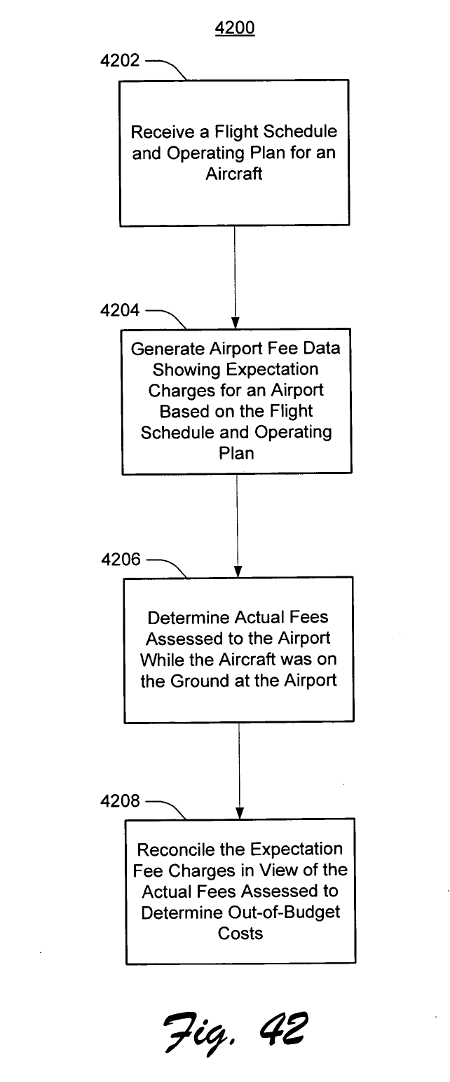

FIG. 42 shows an exemplary procedure 4200 for turnkey aviation budget management, according to one embodiment. More particularly, procedure 4200 shows how an airport reconciles costs actually assessed to the airport regarding in aircraft that is on the ground at the airport. The costs are reconciled in view of a previously determined set of expectation fees (a budget). For purposes of exemplary discussion, operations of procedure 4200 are described with respect to components of FIG. 1. The leftmost numeral of a component reference number identifies the particular figure in which the component was first presented.

At block 4202, turnkey aviation budget management 108 receives a flight schedule 118 and an operating plan 120 for an aircraft. Block 4204, turnkey aviation budget management module 108 generates airport fee data 126 showing expectation charges for the airport based on the flight schedule and the operating plan. At block 4206, turnkey aviation budget management module 108 determines actual fees assessed to the airport while the aircraft was on the ground at the airport. At block 4208, turnkey aviation budget management module 108 reconciles the expectation fee charges (i.e., airport fee data 126) in view of the actual fees assessed to determine out-of-budget costs.

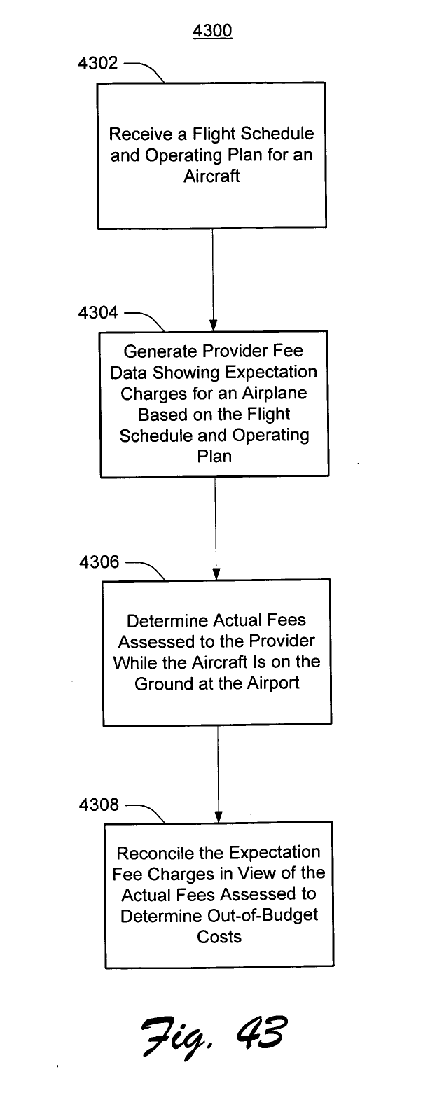

FIG. 43 shows an exemplary procedure 4300 for turnkey aviation budget management, according to one embodiment. More particularly, procedure 4300 shows how a service/equipment provider (i.e. a provider) reconciles costs actually accrued to the provider with respect to in aircraft that is on the ground at an airport. The costs are reconciled in view of a previously determined set of expectation fees (a budget). For purposes of exemplary discussion, operations of procedure 4300 are described with respect to components of FIG. 1. The leftmost numeral of a component reference number identifies the particular figure in which the component was first presented.

At block 4302, turnkey aviation budget management module 102 receives a flight schedule 118 and an operating plan 120 for in aircraft. At block 4304, turnkey aviation budget management module 108 generates provider fee data 126 showing expectation charges for an aircraft (airplane) based on the flight schedule and the operating plan. At block 4306, turnkey aviation budget management module 108 determines actual fees assessed to the provider while the aircraft was on the ground at the airport. At block 4308, turnkey aviation budget management module 108 reconciles expectation fee charges in view of the actual fees assessed to determine out-of-budget costs.

### CONCLUSION

Although the above sections describe turnkey aviation budget management architecture in language specific to structural features and/or methodological operations or actions, the described implementations are not necessarily limited to the specific features or actions described. Rather, the specific features and operations of system 100 are disclosed as exemplary forms of implementing the claimed subject matter.

1. A computer-implemented method comprising:
determining a budget based on a flight schedule and an operating plan for an aircraft, the operating plan being based on the flight schedule to indicate operational flow of one or more of services and equipment applicable to the aircraft between airport arrival and departure times, and fee data; and
automatically reconciling the budget with actual fees assessed for the aircraft while on ground at the airport to identify one or more expenses not in the budget.

2. The method of claim 1, wherein the budget is a budget for an air carrier, an airport, a service provider, an equipment provider, or a charter service.

3. The method of claim 1, wherein the fee data comprises one or more of airport fee data, service provider fee data, and equipment provider fee data.

4. The method of claim 1, wherein the fee data comprises contracted fees.

5. The method of claim 1, wherein the services and equipment are associated with one or more of ground handling, catering, fueling, security, baggage, deicing, crew, cleaning, and customs.

6. The method of claim 1, wherein automatically reconciling the budget with the actual fees assessed for the aircraft further comprises identifying information associated with the one or more expenses not in the budget.

7. The method of claim 1, further comprising generating the flight schedule and the operating plan.

8. The method of claim 1, further comprising presenting a user interface to one or more users, the user interface facilitating one or more of generation of the flight schedule and the operating plan, determination of the budget, and reconciliation of the budget with actual fees assessed.

9. The method of claim 1, further comprising one or more of creating and identifying contractual fee data.

10. The method of claim 1, further comprising providing charge notes to identify at least a subset of the actual fees assessed.

11. The method of claim 1, further comprising providing detailed airport and contact information to facilitate determination of the operating plan.

12. The method of claim 1, further comprising creating one or more reports based on the flight schedule and operating plan, the report's comprising a flight schedule report, a contracts flow report also based on the budget, a contract fee summary report, a reconciliation report, a charge note reconciliation report, fee reports, letters, service provider lists, equipment provider lists, a purchase order based on at least a subset of the one or more expenses not in the budget, and an affidavit attesting to the one or more expenses.

13. A computer-readable medium comprising computer-program instructions executable by a processor for:
determining a budget based on a flight schedule and an operating plan for an aircraft, the budget being a budget for an air carrier, an airport, a service provider, an equipment provider, or a charter service, the operating plan being based on the flight schedule to indicate operational flow of one or more of services and equipment applicable to the aircraft between airport arrival and departure times, and fee data comprising one or more of airport fee data, service provider fee data, and equipment provider fee data; and
automatically reconciling the budget with actual fees assessed for the aircraft while on ground at the airport to identify one or more expenses not in the budget.

14. The computer-readable medium of claim 13, wherein the fee data comprises contracted fees.

15. The computer-readable medium of claim 13, wherein the computer-program instructions further comprising instructions for presenting a user interface to one or more users, the user interface facilitating one or more of generation of the flight schedule and the operating plan, determination of the budget, and reconciliation of the budget with actual fees assessed.

16. The computer-readable medium of claim 13, further comprising creating one or more reports based on the flight schedule and operating plan, the report's comprising a flight schedule report, a contracts flow report also based on the budget, a contract fee summary report, a reconciliation report, a charge note reconciliation report, fee reports, letters, service provider lists, equipment provider lists, a purchase order based on at least a subset of the one or more expenses not in the budget, and an affidavit attesting to the one or more expenses.

17. A computing device comprising:
a processor; and
a memory coupled to the processor, the memory comprising computer-program instructions executable by the processor for:
determining a budget based on a flight schedule and an operating plan for an aircraft, the operating plan being based on the flight schedule to indicate operational flow of one or more of services and equipment applicable to the aircraft between airport arrival and departure times, and fee data;
reconciling the budget with actual fees assessed for the aircraft while on ground at the airport to identify one or more expenses not in the budget; and
presenting a user interface to one or more users, the user interface facilitating one or more of generation of the flight schedule and the operating plan, determination of the budget, and reconciliation of the budget with actual fees assessed.

18. The computing device of claim 17, wherein the budget is a budget for an air carrier, an airport, a service provider, an equipment provider, or a charter service.

19. The computing device of claim 17, wherein the fee data comprises one or more of airport fee data, service provider fee data, and equipment provider fee data.

20. The computing device of claim 17, wherein the computer-program instructions further comprising instructions for creating one or more reports based on the flight schedule and operating plan, the report's comprising a flight schedule report, a contracts flow report also based on the budget, a contract fee summary report, a reconciliation report, a charge note reconciliation report, fee reports, letters, service provider lists, equipment provider lists, a purchase order based on at least a subset of the one or more expenses not in the budget, an affidavit attesting to the one or more expenses.
